(19) United States
(12) Patent Application Publication
(10) Pub. No.: US 2018/0306466 A1
(43) Pub. Date: Oct. 25, 2018

(54) IMPROVEMENTS TO HEATING, VENTILATION AND AIR CONDITIONING SYSTEMS

(71) Applicant: SOLARJOULE IP HOLDING LIMITED, Hamilton Central Hamilton (NZ)

(72) Inventor: Grace Lillian Coulter, Sydney (AU)

(21) Appl. No.: 15/576,803

(22) PCT Filed: May 26, 2016
(86) PCT No.: PCT/NZ2016/050088

§ 371 Date: Nov. 25, 2017

(30) Foreign Application Priority Data
May 26, 2015 (NZ) 707212
Jun. 19, 2015 (NZ) 709298
Aug. 19, 2015 (NZ) 711204
Sep. 9, 2015 (NZ) 712135
Sep. 24, 2015 (NZ) 712679
Dec. 10, 2015 (NZ) 715024

(51) Int. Cl. F24S 10/30; F24S 10/70; F24S 20/67; F24S 80/20; F24S 20/00

(52) U.S. Cl. CPC F24S 10/30; F24S 10/70; F24S 2080/03; F24S 80/20; F24S 20/00; F24S 20/67

(57) ABSTRACT

A solar heat collector (100) is provided which has a plurality of upper air channels (3) arranged adjacently. A first flow control means (20) is provided at a first end of the upper air channels (3) and a second flow control means (20) is provided at a second end of the air channels (3). Each flow control means (20) is movable between a first position in which flow through the upper air channels (3) is substantially prevented and a second position wherein flow though the upper air channels (3) is permitted. Also described are a heat exchanger (100B), a fan (72), and a variety of flow modes.

### STATEMENT OF CORRESPONDING APPLICATIONS

This application is based on the Provisional specification filed in relation to New Zealand Patent Application Numbers 702717, 709298, 711204, 712135, 712679 and 715024 the entire contents of which are incorporated herein by reference.

### TECHNICAL FIELD

The present invention generally relates to apparatus and systems for using solar energy to heat, cool and/or ventilate a space, particularly the interior of a building. The heating apparatus may also be used to dry crops, generate power from thermal syphoning and part of the humidification and dehumidification process of a desalination plant. The invention also generally relates to a heat exchanger for use with or without the apparatus.

### BACKGROUND ART

Ventilation systems can use solar energy throughout the seasons to provide both heating and cooling effects during solar hours (i.e. when solar energy is received). Ventilation systems are particularly used to heat, cool or insulate buildings (or any type of construction). However given a limited number of solar hours, it is useful to conserve or store heat already generated either by solar or other methods.

European Patent Publication No. 2310760 describes a solar air heater combined with a heat recovery system having counter flow air along channel separations running perpendicular to the front wall. The system uses fresh air, reclaimed air from the building or the stored heat from air passing under the building. A disadvantage of this design, for example, is the inability of the heat exchanger to reclaim cooling from the building since it would be adversely influenced by solar heating.

U.S. Pat. No. 2,399,487 describes a heating assemblage provided with a plurality of radially disposed bosses grouped both laterally and longitudinally about a central axis for various heat transfer purposes.

US Publication No US 2004/0237960 discloses a solar air collector with blade-like dampers that open and shut to allow air to enter or exit the collector from the surrounding atmosphere. These damper units each have a number of blades that are open and shut together using a rod. Fluid entry and exit conduits also have their flow controlled by separate dampers. The system described here uses separate dampers for each of the flow paths into the collector—i.e. one damper for the indoor conduit and another damper for the surrounding atmosphere flow path. These have to be controlled separately to alter the flow modes of the system, so the system of US 2004/0237960 is complex to operate and construct.

Patent WO 1985000212A1 describes a solar air heating system that stores solar heat for night time heating. It consists of a subdivided chamber or structure for heat storage, fins for heat exchange that extend from the chamber or structure wall into the storage medium to subdivide the chamber of the structure to improve the heat exchange relationships of the storage material with its surroundings.

PCT Patent Application No. PCT/NZ2013/000185 describes a solar air heating/cooling/ventilation system. It may be desirable to provide a further improved system in which delivery of heated or cooled air to the building interior is made even more efficient and effective using apparatus that is cheaper and/or less complex to manufacture, install and/or operate.

All references, including any patents or patent applications, cited in this specification are hereby incorporated by reference. No admission is made that any reference constitutes prior art. The discussion of the reference states what their authors assert, and the applicants reserve the right to challenge the accuracy and pertinency of the cited documents. It will be clearly understood that, although a number of prior art publications are referred to herein, this reference does not constitute an admission that any of these documents forms parts of the common general knowledge in the art, in New Zealand or in any other country.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Further aspects and advantages of the present invention will become apparent from the ensuing description which is given by way of example only.

### DISCLOSURE OF THE INVENTION

According to one aspect of the invention there is provided a solar heat collector comprising:

a plurality of upper air channels arranged adjacently;
a first flow control means provided at a first end of the upper air channels and a second flow control means provided at a second end of the air channels, each flow control means movable between a first position in which flow through the upper air channels is substantially prevented and a second position wherein flow though the upper air channels is permitted.

Preferably, when in the second position, each flow control means substantially prevents fluid flow through a respective further conduit or opening.

Preferably, each flow control means is moveable to a third position wherein flow through the upper air channels is permitted, and flow though the further conduit or opening is also permitted.

Preferably, the flow control means comprises an elongate blade which is rotatable about a longitudinal axis.

According to a second aspect of the invention there is provided a heat exchanger comprising a body, a first heat exchange channel and a second heat exchange channel in thermal contact with the first heat exchange channel, wherein at least one of the first and second heat exchange channels is provided with a plurality of cylindrical or conical bosses.

Preferably the shape and location of the bosses is selected to increase a resistance to fluid flow in one or more selected areas.

Preferably the shape and location of the bosses is selected to improve the distribution of a fluid flow through at least one of the heat exchange channels.

Preferably a heat transfer layer is provided between the first and second heat exchange channels, and wherein the heat transfer layer is supported by one or more of the cylindrical or conical bosses.

Preferably the body is constructed from a mouldable insulating material or a material which is suitable for additive manufacture (3D printing).

According to a third aspect of the present invention there is provided a fan comprising a rotor rotatable mounted within a housing and means for rotating the rotor, the rotor comprising an elongate central portion having a longitudinal axis, and at least one blade extending from the central portion, the or each blade having a substantially helically shaped portion, wherein a first opening is provided on a first side of the housing and a second opening is provided on a second side of the housing opposite the first side, and wherein a centre of the second opening is longitudinally offset from a centre of the first opening.

Preferably the blade comprises a second substantially helically shaped portion, the second substantially helically shaped portion having an opposite chirality to the first substantially helically shaped portion.

Preferably the first portion is substantially continuous with the second portion.

Preferably the first opening is substantially axially aligned with an intersection of the first and second substantially helically shaped portions, and wherein a third opening is provided on the second side of the housing, the third opening located on an axially opposite side of the first opening to the second opening.

Preferably the central portion is substantially helically circular and the outer portions are substantially helically conic.

According to a fourth aspect of the invention there is provided a fan comprising a rotor rotatable mounted in a housing and means for rotating the rotor, the rotor comprising an elongate central portion having a longitudinal axis, at least one pair of blades comprising a first blade and a second blade offset from the first blade, the first blade having a root which is substantially helically shaped to the longitudinal axis and a concave pressure face, the second blade having a having a root which is substantially helically shaped_to the longitudinal axis and a substantially convex pressure face, a first opening provided in a first side of the housing and axially aligned with the first blade, and a second opening provided in a second side of the housing opposite the first side, the second opening axially aligned with the second blade.

According to a fifth aspect of the invention there is provided a heat exchanger comprising a body, a first heat exchange channel and a second heat exchange channel in thermal contact with the first heat exchange channel, wherein at least one of the first and second heat exchange channels is in fluid communication with a fan according to the third aspect or the fourth aspect.

According to a sixth aspect of the invention there is provided a heat exchanger according to the second aspect of the invention provided with a fan according to the fourth or fifth aspects.

According to a seventh aspect of the invention there is provided a solar heat collector of the first aspect combination with and in fluid connection with a heat exchanger according to any one of the second, fifth or sixth aspects.

According to an eight aspect of the invention there is provided a solar heat collector comprising a heat exchanger according to the second, fifth or sixth aspects.

According to an eight aspect of the invention there is provided a solar collector of first, seventh or eighth aspects provided with a fan of the first or second aspects.

According to a further aspect of the invention there is provided a solar collector and one or more flow control means, the solar collector configured to operate in one or more of the flow modes herein described.

Preferably the solar collector comprises a heat exchanger.

According to a further aspect of the invention there is provided a method of operating a solar collector and/or a heat exchanger substantially as herein described.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

### BRIEF DESCRIPTION OF THE DRAWINGS

FIG. 1 is a perspective view of one embodiment of a solar heat collector of the present invention, with a side wall removed for clarity.

FIG. 2 is a cross-section side view of an embodiment of the solar collector mounted to a roof.

FIG. 3 is a cross-section end view of an embodiment of the solar collector.

FIG. 4 is a perspective view of a heat transfer sheet.

FIG. 5 is an exploded view of a heat exchange unit of an embodiment the present invention.

FIG. 6A is a perspective view of body of a heat exchange unit of an embodiment the present invention.

FIG. 6B is a perspective view of a second portion of a heat exchange unit of an embodiment the present invention.

FIG. 6C is an enlargement of a boss.

FIG. 7 is a perspective view of another embodiment of a solar heat collector of the present invention, with a side wall removed for clarity.

FIG. 8 is a diagrammatic perspective view of a damper box attached to one end of a solar energy collecting portion of a solar collector.

FIG. 9 is a diagrammatic perspective end view of another embodiment of a damper box.

FIG. 10 is a diagrammatic perspective view of an embodiment of a solar collector including damper boxes at each end of the solar energy collecting portion.

FIG. 11 is a diagrammatic perspective view of another embodiment of a solar collector including damper boxes at each end of the solar energy collecting portion.

FIG. 12 is a diagrammatic cross section of a multiple level building with a solar collector provided on each level and connected to a common conduit.

FIG. 13 is a diagrammatic cross section view of one configuration of damper boxes for use with the system of FIG. 12.

FIG. 14 is a diagrammatic cross section view of another configuration of damper boxes for use with the system of FIG. 12.

FIG. 15 is a diagrammatic cross section view of another configuration of damper boxes for use with the system of FIG. 12.

FIGS. 16-22 are diagrammatic cross-section views of solar collectors of the present invention operating in various flow modes.

FIG. 23 is an end view of one embodiment of a heat storage member.

FIG. 24 is an end view of another embodiment of a heat storage member.

FIG. 25 is a diagrammatic perspective view of another embodiment of a heat storage member.

FIG. 26 is a diagrammatic perspective view of another embodiment of a heat storage member.

FIG. 27 is a diagrammatic top view of a heat storage member with fins orientated transversely.

FIG. 28 is a diagrammatic top view of a heat storage member with fins orientated longitudinally.

FIG. 29 is a diagrammatic side view of one embodiment of a heat collector of the present invention installed on a roof.

FIG. 30 is a schematic diagram of a heat pump of an embodiment of the invention.

FIGS. 31a-l are diagrammatic top views of various embodiments of heat exchangers of the invention, showing locations for the entries and exits for exterior and interior air.

FIG. 32 shows a diagrammatic perspective view of an embodiment of a fan of the invention, with a tube shown in outline for clarity.

FIG. 33 shows a diagrammatic perspective view of one side of the fan of FIG. 32 with the tube shown.

FIG. 34 shows a diagrammatic perspective view of the opposite side of the fan of FIG. 32.

FIG. 35 shows a diagrammatic perspective view of an alternative rotor design.

FIG. 36 shows a cross section of one portion of the rotor.

FIG. 37 shows a cross section of another portion of the rotor.

FIG. 38 shows a diagrammatic perspective view of another alternative rotor design.

FIG. 39 shows a diagrammatic perspective view of another embodiment of a fan from one side.

FIG. 40 shows a diagrammatic perspective view of the fan of FIG. 39 from the opposite side.

### BEST MODES FOR CARRYING OUT THE INVENTION

In one aspect the present invention generally relates to apparatus and systems for using solar energy to heat, cool and/or ventilate a space, particularly the interior of a building. Movement and heat or cooling of the air may also be used for other purposes such as generating power, for example by a thermal syphoning/solar chimney effect. Solar air heaters may also be used as part of the humidification and dehumidification process that removes salt from water, to dry products such as timber and other crops, or to help to regulate the temperature in a glass house both from heating and thermal syphoning when cooling is required.

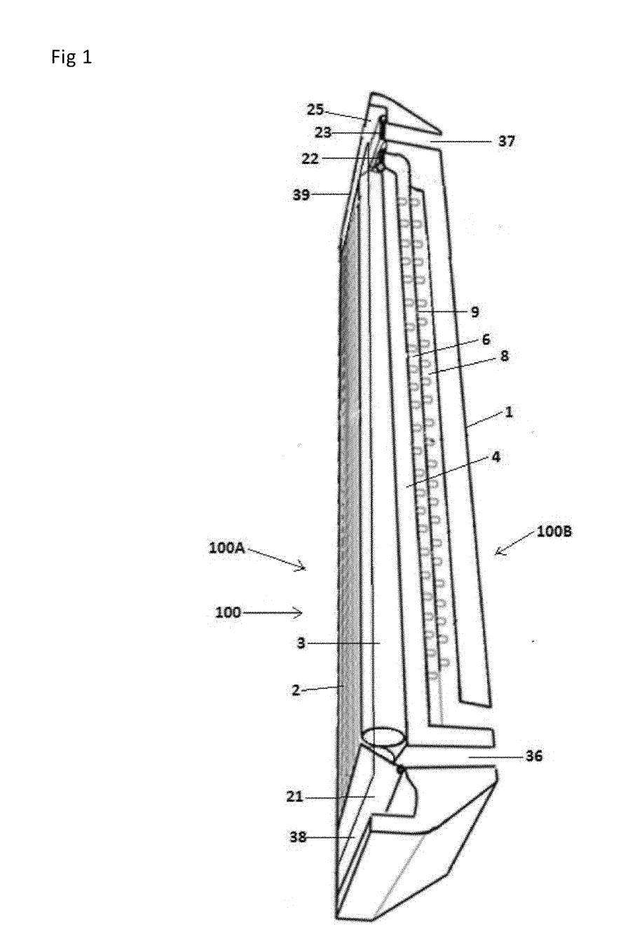

Referring first to FIGS. 1 and 2 a solar heat collector, ventilation device, heating device or cooling device is generally referenced by arrow 100, and is hereinafter referred to as a collector 100. The collector 100 has a housing or base 1 and a top panel 2. Top panel 2 is made from a transparent material such as glass or transparent plastic to allow solar radiation to heat components under the top panel 2. Under the top panel 2 is one or more collector air channels 3 mounted generally longitudinally in the collector unit 100. The collector channels 3 may be formed from one or more pipes or other conduits and may be arranged in parallel. The collector channels 3 may comprise structures to promote the turbulence of air inside the channels, for example protrusions on the inner surface of the channels or helical fins, such as described in more detail in PCT/NZ2013/000185, the contents of which are herein incorporated by reference. The collector channels 3 may be in contact with top panel 2 or may be closely positioned thereto. In some embodiments an air space exists between the top panel and the collector channels and this air space is heated by incident solar energy. In use, the air in the collector channels 3 is heated by solar energy. The collector channels 3 may be constructed from any material suitable for conducting thermal energy such that the air in the channels is heated by incident solar energy.

The upper part of the solar heat collector 100, which comprises the collector channels 3, is generally referred to as the solar energy collecting portion 100A of the apparatus 100, as it functions in use to collect or absorb solar energy and to heat air passing through the channels 3. When the collector 100 is positioned so that one end of the collector channels 3 is more elevated than the other end, as shown in FIG. 2, the heating of the air in the channels 3 will tend to cause air to flow upwards through the channels 3 unless there is mechanical forcing of air in the opposite direction.

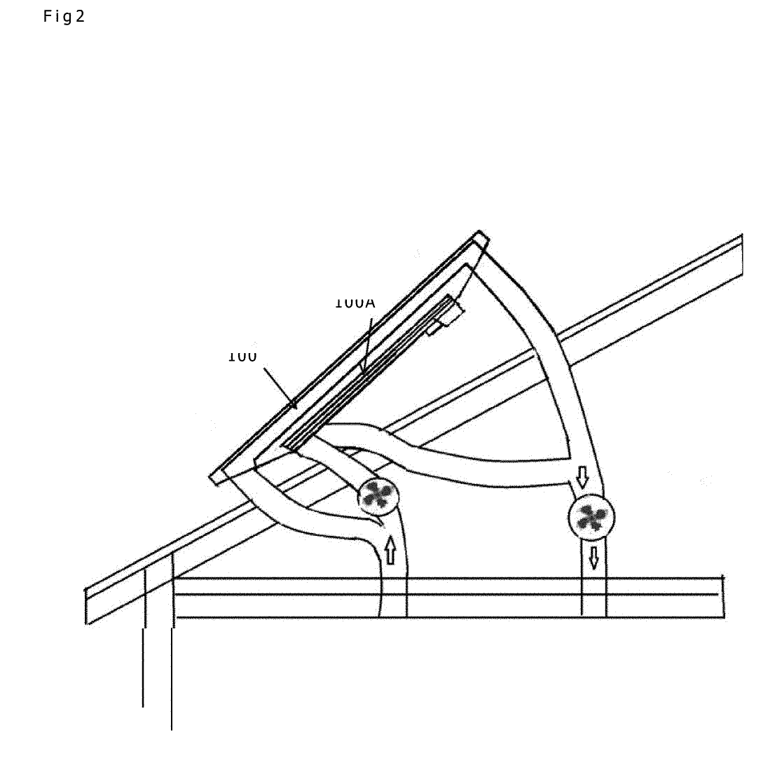

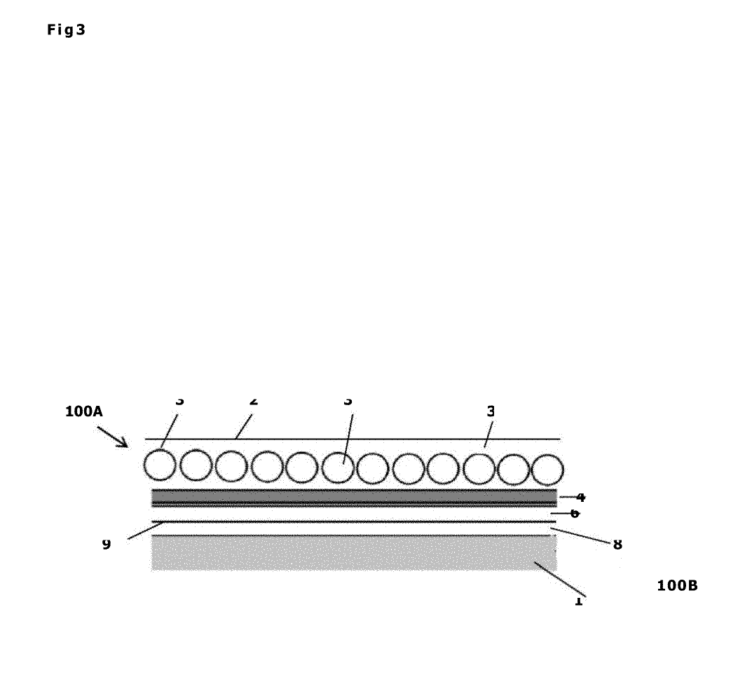

In the embodiment shown in FIGS. 1 and 3, collector channels 3 are positioned on top of a body panel or insulation layer 4 which is provided to base 1. Formed between insulation layer 4 and base 1 are a first heat exchange air channel 6 and second heat exchange air channel 8. The heat exchange air channels 6, 8 are arranged generally parallel with the upper and lower surfaces of the collector 100. They may comprise longitudinal, lateral or diagonal channels allowing air to pass through or, as in the embodiment shown, may comprise voids or spaces through which air can pass.

The first and second heat exchange channels 6, 8 are fluidly separated but in thermal contact with each other, i.e. heat energy can be exchanged between the two channels. In the embodiment shown, a heat transfer layer 9 is provided between the channels. In other embodiments more than two parallel heat exchange channels may be provided.

### Heat Exchanger

The lower part of the solar heat collector 100, which comprises the first and second heat exchange air channels 6 and 8, may be generally referred to as the heat exchange part 100B of the apparatus as it functions in use to allow heat to be exchanged between air flowing through the air channels 6 and 8.

The ends of each of the collector channels 3 and heat exchange channels 6, 8 are fluidly connected to each other and to openings in the solar energy collecting portion 100A that fluidly connect the respective channels to the outside air and/or the building interior when the solar energy collecting portion 100A is in use, although the fluid connections between these channels/spaces may be selectively blocked by flow control means as discussed below. The fluid connections between the channels/spaces may be effected by conduits connecting same, for example air spaces formed by parts of the base 1, insulation layer 4, top panel 2, channels 3 and/or by any other component of the collector.

In some embodiments the solar energy receiving portion 100A and heat exchanger 100B may operate independently from each other and may or may not share the same housing. In this context, “independent operation” of the solar energy receiving portion 100A and heat exchanger 100B will be understood to mean that the two parts of the apparatus that perform solar collection and heat exchange operations do not have airflow channels that are (or can be, for example through activation of dampers) directly fluidly connected, without any intervening conduit.

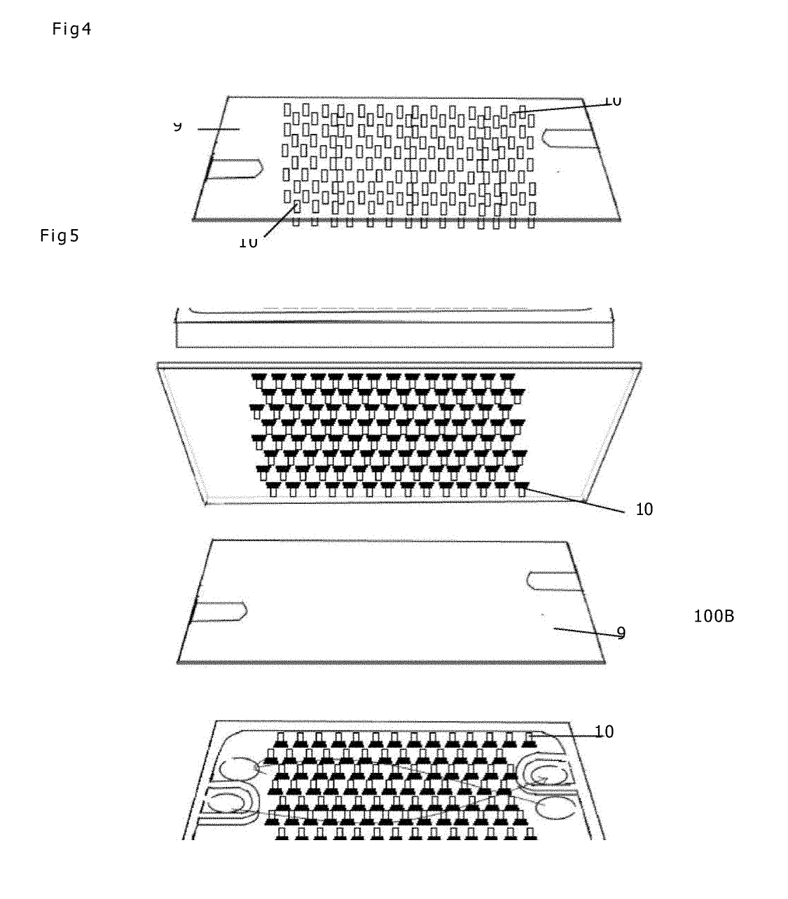

Referring next to FIG. 4, in some embodiments heat transfer through the heat transfer sheet 9 may be improved by providing projecting heat transfer elements 10 which extend through the sheet 9 and increase the heat transfer area. In one embodiment the heat transfer elements 10 comprise lengths of aluminum rod. Additionally, or alternatively, heat transfer elements 10 may be embedded in the upper and/or lower surfaces of heat exchange unit 100B, as shown in FIG. 5. In this embodiment the heat transfer elements preferably extend into contact with the heat transfer sheet 9. As a cheaper alternative, the projecting elements 10 may be part of the mould itself. As such they would function to mix and evenly spread the air flow.

FIGS. 6A, 6B and 6C show an embodiment of the heat exchange unit 100B. The heat exchange unit 100B in this example is separated from the solar energy receiving portion 100A. In some circumstances where heat from the solar energy collecting portion 100A affects the performance of the heat exchanger 100B due to heat transfer across the insulating layer 4, it may be advisable to reduce the area available for direct heat transfer between the solar energy collecting portion 100A and the heat exchanger 100B. For example, the heat exchanger 100B may be positioned beside the solar energy collecting portion 100A. As is described further below, both the solar energy collecting portion 100A and the heat exchanger 100B can still operate as an integrated system, whereby a controller determines which is in operation based on conditions such as temperatures outside the temperature controlled space, inside the temperature controlled space, and within the collector 100 itself. In some circumstances where, for example, there is little solar gain available to the solar energy collecting portion 100A due to shading, the heat exchange unit 1006 may be used without the solar energy collecting portion 100A. As shown in FIGS. 6A-6C, the heat exchange unit 100B may comprise a first portion 11 and a second portion 12. The first portion 11 comprises the base 1, and comprises a first surface 12 that defines a lower surface of the second heat exchange channel 8. The base 1 also defines side walls of both the first and second heat exchange channels 6, 8. The second portion 13 forms the insulation layer 4, and comprises a second surface 14 which defines an upper surface of the first heat exchange channel 6.

A plurality of conical or cylindrical bosses 15 may protrude from the first and/or second surfaces 12, 14. The bosses 15 may serve to support the heat transfer layer 9 between the first and second heat transfer channels 6, 8. This may allow the use of a very thin heat transfer layer 9, for example a thin sheet of aluminum. The bosses 15 may additionally, or alternatively, serve as baffles to create turbulence and mixing of the air flow within the first and second surfaces 12, 14.

The bosses 15 may take the form of small cylindrical or conical members extending into the airflow path in the heat exchange channels 6, 8. The bosses 15 may extend across part of the height of the heat exchange channel or fully across (that is, each boss 15 may contact the top and bottom surfaces of the channel). The bosses 15 may be laid out in an array across the area of the channel 6, 8, for example in an isometric arrangement, although other arrangements are also possible, e.g. rectangular grid or randomly placed. The bosses 15 may act to interrupt air flow through the channels and create turbulence, assisting in heat transfer. Other structures may be used in other embodiments of the invention, for example bosses of different cross-sectional shapes or other shaped protrusions

This design using bosses 15 makes it possible to control the density of the obstruction to air from through the heat exchange channels 6, 8. For example, in the example of the two air flows of the heat exchange unit 100B in FIGS. 6A and 6B, air may flow along the path of least resistance and may therefor tend not to flow over some areas. By concentrating more bosses 15 in the areas of less resistance, the air flow may be increased in other areas and the distribution of the air flow through the heat exchange channel may be improved. Diamond shaped protrusions 16 located near the source of the air flow can also help to distribute the air flow to the outer reaches of heat transfer channels 6 and 8.

In some embodiments heat transfer elements 10 as described above with reference to FIG. 4 may also serve as baffles within the heat transfer channels 6, 8. These heat transfer elements 10 can be made from a heat transferring material, like aluminum, which is embedded in penetrations in the foam housing material as shown by the rings in FIG. 5. Alternatively pins may penetrate the heat transfer sheet 9 with possible spacers threaded through the pins as shown in FIG. 4. Alternatively the bosses may be part of the foam insulating housing mold as shown in FIG. 6A to 6C. Due to the structural nature of the bosses, alternating heat transfer channels 6 and 8 may be stacked if more air flow is required. In this case, alternating rings around entry and exit openings can block the mixing of air flows between heat transfer channels 6 and 8 allowing these channels to remain separate.

When the solar energy collecting portion 100A and heat exchanger unit 100B share the same housing, the first heat exchanger portion 11 may form a main frame for supporting damper boxes of the solar energy collecting portion 100A, as is described further below. Alternatively, such as when the heat exchanger is detached from the solar energy collecting portion 100A, the second heat exchanger portion 13 may form the main frame, with the first heat exchanger portion 11 detachable from the back. This may be desirable, for example, when the heat exchanger 100B is positioned vertically in an apartment.

In one embodiment base 1 of the collector 100 is formed from a mouldable insulating material such as a polyurethane foam so that the base frame, insulation layer 4 and other parts of the collector housing may all be made as an integrated unit, reducing costs, making the collector lighter and possibly better insulated than collector units made of other materials, for example aluminium and insulating boards. In other embodiments the base 1 may be formed from a material which is suitable for additive manufacture (3D printing). A plastic foam base also provides versatility in terms of shaping and moulding to enhance a smooth air flow as well as support for the solar energy collecting portion 100A when sharing the same housing as the heat exchanger 1006. This choice of material also makes it easier for bosses 15 and/or heat transfer elements 10 to be provided in the heat exchanger unit 1006. In one embodiment heat transfer elements 10 may be embedded in the foam during the manufacturing process. The bosses 15 may be integrally formed as part of the manufacturing process.

A plastic foam base may be more easily adapted to suit different contexts e.g. a roof, a wall, etc. In another embodiment of the invention, the heat exchanger unit 100B, which may be made from polyurethane foam for example, is separated from the solar energy collecting portion 100A which is also made from a similar material.

### Dampers

In many embodiments the solar energy collecting portion 100A is provided with flow control means 20 to selectively block or partially block at least one of the conduits or channels, to selectively permit, prevent and/or regulate air flow between any one or more of the collector air channels 3 the first heat exchange channel 6 and the second heat exchange channel 8 and the building interior, the outside air, and/or each other.

In the embodiment shown in FIG. 1 the flow control means 20 take the form of first, second, and third dampers 21, 22, 23 comprising fin-shaped panels which are able to be actuated to selectively block the air channels and conduits of the solar energy collecting portion 100A.

FIG. 1 shows an embodiment in which the third damper 23 and the second damper 22 selectively blocks or opens to fluidly connect the first heat exchange channel 6 of the heat exchanger 1006 with the outside air through an opening 25 to the exterior. The collector channels 3 also fluidly connect to the exterior opening 25, depending on the setting of the dampers. Optionally, an exhaust fan (not shown) positioned at opening 25 may be used to propel air through both the collector channels 3 and/or the first heat exchange channel 6. In other embodiments, other types of flow control means such as flaps or valves may be used.

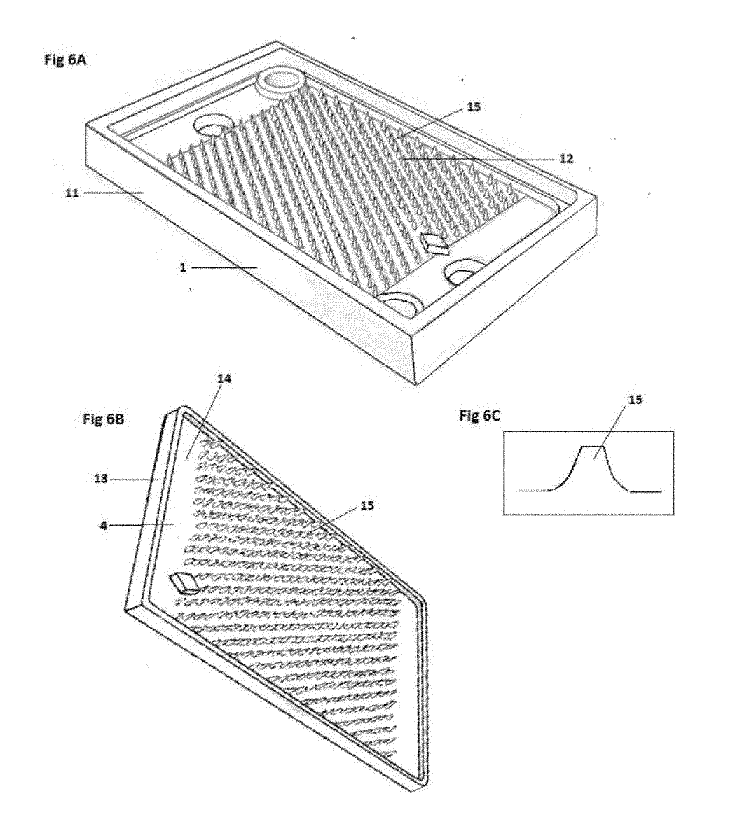

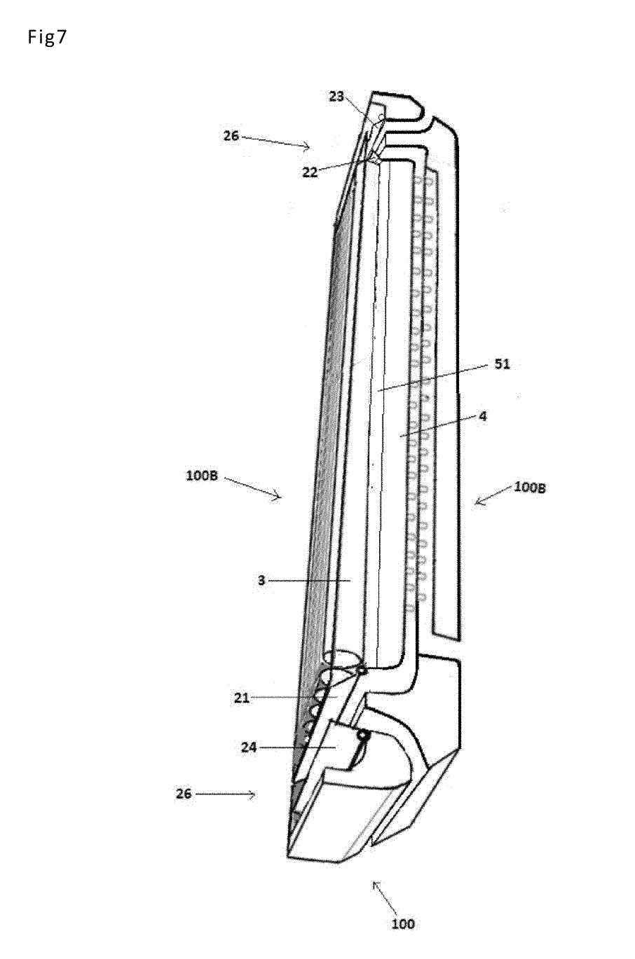

In use the dampers 21-23 are selectively controlled to alter the fluid connection of the collector channels 3 and first and second heat exchange channels 6, 8 with each other and/or with the outside air and/or the building interior in order to heat, cool and/or ventilate the building. The damper configuration is controlled based on the sensed temperature of air in the collector 100, the building and/or outside air, and/or other parameters, for example time of day, time of year, solar radiation, amount of incident light, pressure sensor, etc. Some examples of how the dampers may be so selectively controlled are explained below. The embodiment shown in FIG. 7 has an additional fourth damper 24.

The collector and channels therein may be fluidly connected to a plurality of external conduits which are provided as part of a ventilation system according to an embodiment of the invention and, in use, are positioned to connect the channels 3, 6, 8 of the collector to the outside air and/or building interior. Air flow within the conduits, or in some embodiments, within the channels 3, 6, 8 of the collector, may be mechanically controlled by flow driving means, for example one or more fans or impellers. Operation of the flow driving means is controlled based on parameters such as those described above to control the flow of air around the ventilation system in order to heat, cool and/or ventilate the building as desired based on the sensed parameters.

In the embodiments shown in FIGS. 1 and 7 the solar energy collecting portion 100A comprises transversely elongate (i.e. extending across the width of the collector) spaces in which the damper fins 21-24 are able to move. These spaces may be described as damper boxes 26 and are an integral part of the solar energy collecting portion 100A, i.e. the damper fins or blades 21-24 are housed in a space or unit attached at the end of the collector tubes 3.

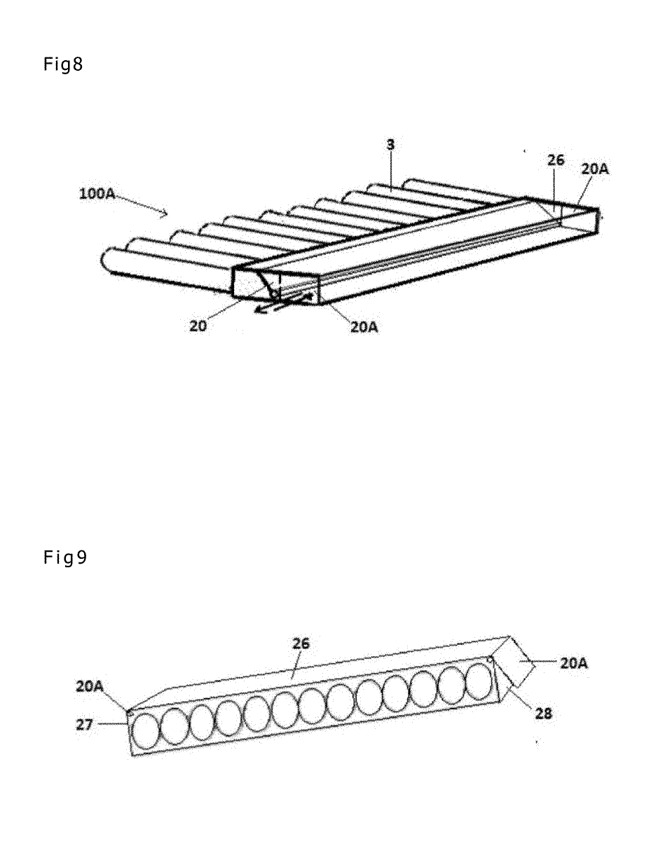

FIG. 8 is an example of a damper box 26 connected to a parallel array of collector channels or tubes 3. In this example, a damper blade 20 is transversely positioned across the width of the solar energy collecting portion 100A. In this embodiment the damper box 26 may include one or more damper blade(s) 20A positioned longitudinally to block or unblock air flow to central supply or exhaust ducts. In these examples the damper blades 20 pivot around an axis which extends transversely across the width of the solar energy collecting portion 100A. The axis of rotation may be located adjacent any corner of the damper box 26. In alternative embodiments the damper blades may slide to block, unblock or partially block selected conduits or channels, or they may pivot centrally like a butterfly.

In some cases the indoor and surrounding atmosphere flow path conduits may have already been selected before they enter the solar collector and heat exchanger such as from a central supply or exhaust duct. In general the invention includes a damper flap(s) mounted in any way in the box such that the collection tubes are fluidly connected to the inside and in another configuration the tubes are fluidly connected to the outside. This contrasts, for example to dampers housed at a point in the ventilation system that is fluidly spaced from the collector 100, as is described in PCT/NZ2013/000185. This has been found to provide efficiency in the manufacture and cost of the collector apparatus, as well as being compact in design, improving air flow and heating.

FIG. 9 illustrates a damper box 26 with a longitudinal damper 20A at either end of the box. The damper box 26 is provided at one end of the solar energy collecting portion 100A connected to the openings of the tubes 3, and is provided with exterior openings 27, 28 adjacent the dampers 20A. The system described here uses separate dampers 20A for each of the flow paths either out of, or into, the solar energy collecting portion 100A—i.e. one damper for the indoor conduit and another damper for the surrounding atmosphere flow path. The configuration shown may suit cases, such as apartment blocks, where it may be desirable to share a building's central ducting system. In other embodiments the pivot for the damper blade may be in the centre of the damper box ends and the blade extends diagonally.

In some embodiments the base 1 may define the bottom and one outer side of a damper box.

FIGS. 10 and 11 are further examples of possible locations of damper boxes in relation to the solar energy collecting portion. The damper boxes 26 here are positioned at either end of the solar energy collecting portion 100A in close proximity to the collector channels 3, and form an integral feature of the collector.

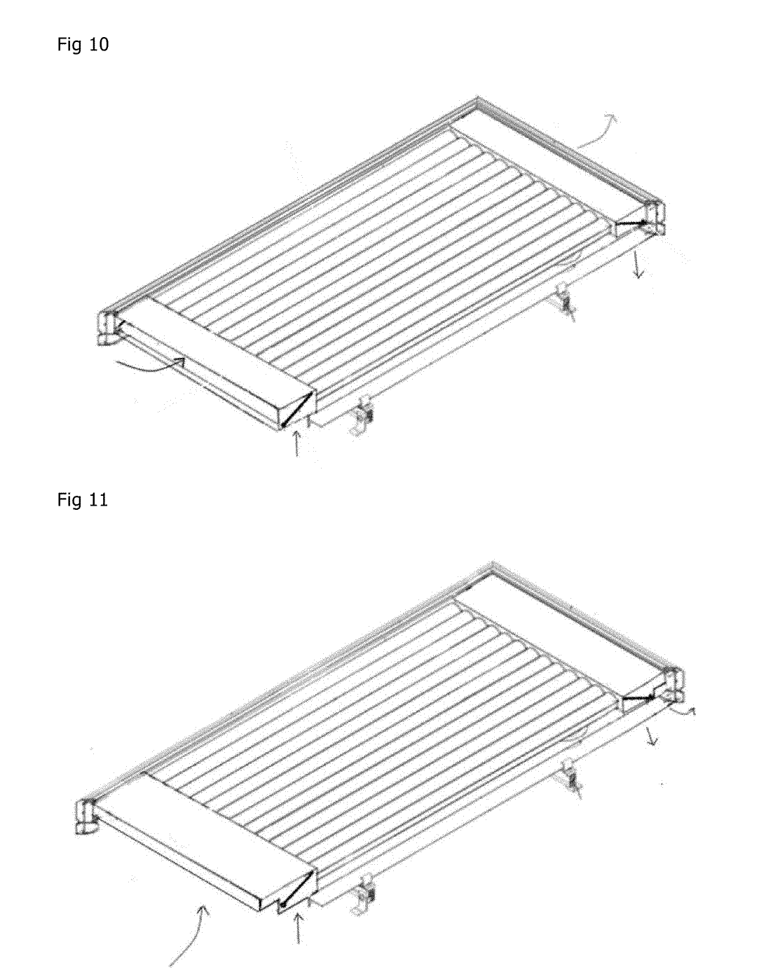

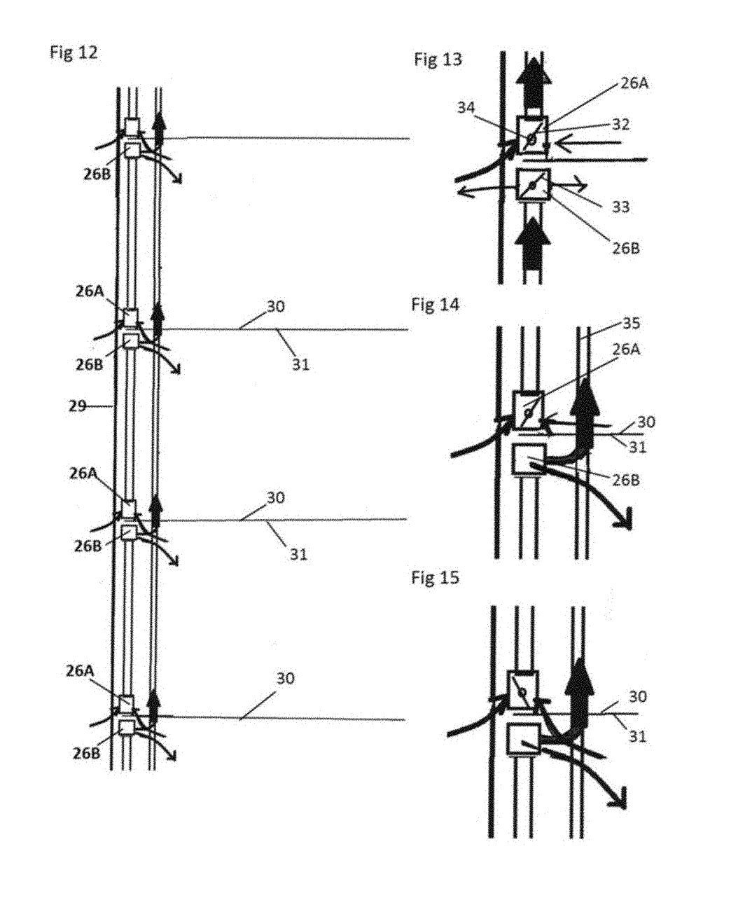

FIGS. 12 to 15 show examples of integrating a plurality of solar energy receiving portions 100A (including dampers) up a series of stories or levels in a building column. The embodiment in FIG. 12 has damper boxes 26A positioned at the lower end of each solar energy collecting portion 100A near the floor 30 and second damper boxes 26B at the upper end by the ceiling 31. To minimise the effect of wind and increase the heat uptake it is preferable for the dampers and collector to be behind high transmissivity glass or some other transparent material 29. In FIG. 13 a single damper 32 controls the intake of air from either outside the building or from within the building, and damper 33 controls the exit of air to the outside or to inside the building. In this embodiment the damper pivot axis 34 is in the centre of the damper box and the blade extends diagonally. Instead of air exiting to the outside directly, FIG. 14 is an example of how the total amount of air from the collector 100 can be carried up to the next level by one or more conduits 35. Uses for this could be to generate electricity from rising air movement (solar chimney effect), space heating a pool or sauna, growing plants, drying clothes or products in the upper floor of the building for example. These are schematic drawings only and so do not represent the exact location e.g. conduit 35 is more likely to be on the side of the collector 100 using a damper configuration such as the one described in FIG. 9. As with the damper described above, the pivots for the dampers in this embodiment can be located differently from that shown, or they could slide for example. In general the objective is to provide a good air seal at either side of the damper box.

FIG. 15 is similar to FIG. 14 except it is an example of air entering the solar energy collecting portion 100A from the upper level of the floor or story below (i.e. from the region adjacent the ceiling 31). This may have an advantage in summer to extract the warmest air in the room that tends to be below the ceiling 31.

As is described above, the damper boxes 32, 33 are preferably an integral part of the solar energy collecting portion 100A, i.e. the damper blades are housed in a unit attached at the end of the collector tubes rather than being housed at a point of the ventilation system that is fluidly spaced from the collector unit, as in PCT/NZ2013/000185. This has been found to provide efficiency in the manufacture and cost of the system, as well as being compact in design, improving air flow and heating.

It will be understood that the dampers described pivot, but in general the invention includes a damper flap(s) mounted in any way in the box such that the collection tubes are fluidly connected to the inside when the damper is flap or blade is in one position, and the tubes are fluidly connected to the outside when the damper is flap or blade is in a second position. For example, the blade(s) could slide or they could pivot centrally like a butterfly.

Air seals made from, for example, rubber, are in some embodiments fixed to the ends of the blade(s) or to the inside of the damper box to ensure a good air seal in conduits or spaces of the collector. A seal may also be required where the pivot hinges. Alternatively, the dampers are made from a material that is sufficiently rigid but still effectively seals against the surface or component against which it abuts.

One or more actuators are connected to each damper, for example at the pivot axis, and to a control system. The actuator holds the blade with sufficient force so that an air seal is maintained. In general the invention consists of a damper box and damper(s) preferably such that the inside of the box is accessible.

In this way the damper system can enable solar energy to be harnessed throughout the seasons in a simpler way. Alternatively, where the solar energy collecting portion 100A and heat exchanger 100B share the same housing, the dampers can direct flow to the heat exchanger 100B to conserve existing heat through reclaiming heat. A variety of flow modes is essential to achieving versatility in a solar air heater and in coupling a solar air heater with a heat exchanger. Alteration of the flow modes (i.e. blocking/unblocking of the indoor/building interior or outdoor conduits) in the heat exchange unit can be achieved either independently from the solar collector or alternatively using one or more dampers also provided to the solar collector or additional to it.

FIG. 1 illustrates an embodiment in which first and third dampers 21, 23 are provided at either end of the solar energy collecting portion 100A. In this embodiment, a second damper 22 is provided at one end of the unit and selectively blocks a fluid connection between the first heat exchange channel 6 and the space at one end of the collector channels 3. In other embodiments the heat exchange part 100A of the device operates independently from (i.e. not fluidly connected with) the solar energy collecting portion 100A and in those embodiments damper 22 may not be present. If the system is configured such that the solar energy collecting portion 100A and heat exchange 100B parts of the device share for example, a fan and entry/exit conduit, then damper 22 is closed to the heat exchanger 100A allowing dampers 21, 23 to function for the different solar collector modes when the solar energy collecting portion 100A is in use and the heat exchanger 100B is not in use.

The solar collector modes when damper 22 blocks heat exchanger channel 6 are as follows:

When damper blade 21 blocks conduit 36 and damper blade 23 blocks conduit 37, both of which are in communication with the interior of the building or temperature controlled space, air from the exterior of the building or temperature controlled space can enter and exit the solar energy collecting portion 100A via openings 38 and 39.

When both damper blades 21, 23 are unblocked to conduits 36 and 37 to the interior of the building or temperature controlled space, and blocked to the exterior via openings 38 and 39, air can enter from the interior and flow back to the interior.

When damper blade 21 is blocked to the exterior via opening 38 and unblocked to the interior conduit 36, and damper blade 23 is unblocked to the exterior at opening 39 and blocked to the interior conduit 37, air enters from the interior and flows to the exterior. When damper blade 21 is blocked to conduit 36 and unblocked to opening 38 and damper blade 23 is blocked to opening 39 and unblocked to conduit 37, air can enter from the exterior and flows to the interior. When damper blade 21 is partially blocked to opening 38 and conduit 36, air enters from the exterior and the interior.

When damper blade 23 is partially blocked to opening 39 and to conduit 37, air exits to the exterior from the exterior and the interior.

So on cold winter days, the lower damper blade 21 can be unblocked to opening 38 and the upper blade 23 unblocked to conduit 37 (damper 22 to the heat exchanger 100B remains blocked) allowing fresh air to enter and be heated either by the sun and/or by a temperature exchange from exhausted warm air transferring heat to the captured fresh air.

On hot summer days, the lower damper 21 can be blocked to opening 38 and unblocked to conduit 36 (so that air is drawn out of a building by thermal syphoning) and the upper damper 23 blocked to conduit 37 and unblocked to opening 39 so that air is drawn outside. This may be done passively without a fan by creating a heat differential between the temperature in the solar energy collecting portion 100A and the temperature outside. As hot air naturally rises, air is drawn up from a vented building and out the solar chimney. The amount of air flow can be controlled by the damper blades fully or partially blocking or unblocking conduits 36 and 37 and openings 38 and 39.

Using various combinations of the damper blades blocking or unblocking conduits and openings, leads to a great deal of control and versatility of use. For example, if the solar energy collecting portion 100A gets above a certain heat and needs to be cooled, both dampers 21 and 23 could be blocked to conduits 36 and 37 so that fresh air directly flows through the collector channels 3, thus self-cooling by convection. Or if both dampers 21 and 23 are blocked to openings 38 and 39 (or lower damper partially blocked), internal air could be recycled from the inside of the building (or roof space for example) back to the inside. Sometimes the air in the roof space may need to be extracted to the outside to help cool down the building in summer or alternatively the additional heat in the roof space can be used in winter and so the same dampers could be used to direct this flow as well.

In the embodiment of FIG. 1, air can enter and exit from above and/or below the device but in other arrangements conduits and openings for air to enter or exit may be from the outer ends or the sides. In some cases where the heater is on a roof it may be advantageous to provide the entry and exit openings and conduits under the lid with better shelter from the weather. FIG. 1 is an example of an embodiment in which a damper blade 21 or 23 operate to direct entry and exit of air from above or below them. This arrangement is particularly useful when the collector 100 is mounted in a substantially vertical orientation. In other embodiments air may enter and exit the solar energy collecting portion 100A from underneath, or from the ends of the collector. These embodiments may be particularly useful when mounted on a roof/wall. There are other damper blade arrangements such that the damper blades are on the sides of the damper box allowing air to enter and exit from the sides.

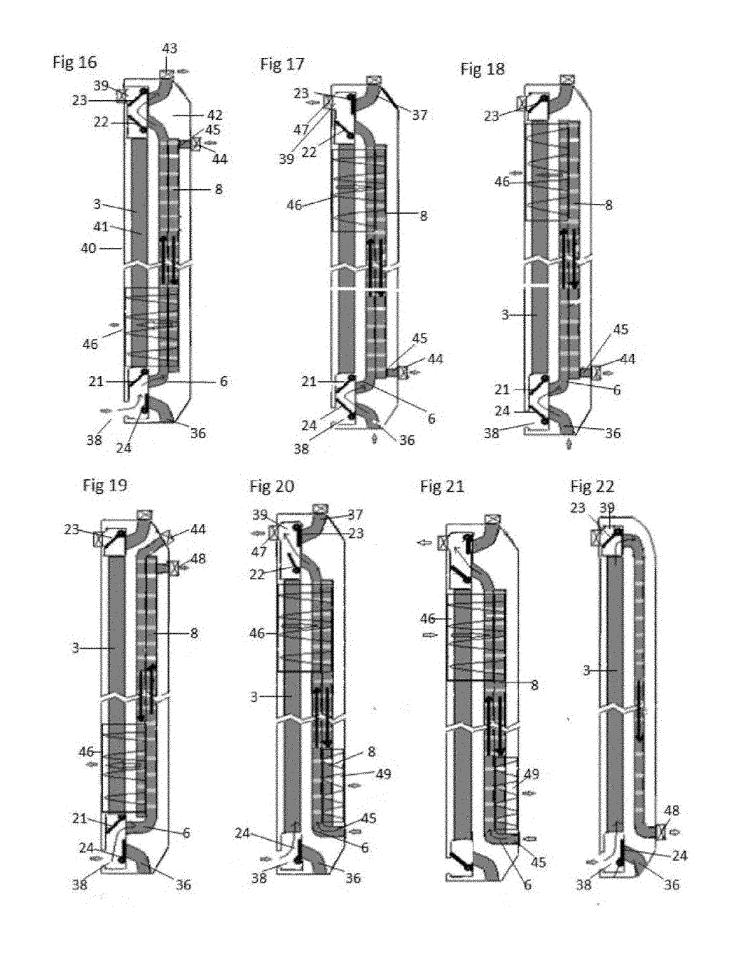

FIGS. 16-22 are side cross-sectional view illustrations of some other embodiments of the invention showing alternative possible arrangements of dampers, fans, conduits, etc when the collector 100 is mounted in a vertical orientation. The unit 100 may be configured to be mounted on coasters or rollers so that it can more easily be installed and maintained and be located on the sunny side of the building in front of a suitably designed glazed window 40. In these embodiments the solar energy collecting portion 100A may not be provided with a top panel 2, as the building's existing window 40 may fulfil the same function. A heat absorbing unit or cassette 41, comprising collector channels 3 and damper boxes 26, at either end may be installed close to the glazing. The cassette 41 and a heat exchanger 100B may be located within an insulated housing 42, or example using the construction described above with reference to FIGS. 6A-6C.

### Flow Modes

Referring to FIG. 16, exterior air is drawn in via opening 38 and fan 43 to the interior of the unit. Damper 24 is blocked to conduit 36 and unblocked to opening 38 and damper 21 is blocked to collector channels 3 and unblocked to first heat exchange channel 6, allowing exterior air to flow through heat exchange channel 6 which is heated by interior air flowing in counter flow along second heat exchanger channel 8. A damper 22 blocks collector channels 3 and damper 23 blocks opening 39 allowing fan 43 to blow heated fresh air into the interior.

Interior air is drawn in via fan 44 through conduit 45 into heat exchanger channel 8. The air transfers its heat to heat exchanger channel 6 and is then exhausted out an elongated passage 46 directly out an opening in a window or into a central exhaust pipe that services the building. This arrangement with four dampers 21-24 allows air from the solar energy collecting portion 100A and the heat exchanger 100B to share the same openings 38, 39 and the same fan 43. During solar hours the solar energy collecting portion 100A uses these openings and fans and during non-solar hours the heat exchanger channel 6 uses them.

Referring next to FIG. 17, interior air is drawn in via conduit 36 and fan 47 to the exterior. Dampers 24, 21, 22 are blocked to the exterior at opening 38 and to the collector channels 3 and damper 23 is blocked to conduit 37 allowing air to flow through heat exchanger channel 6 where it transfers its heat to air flowing in counter-flow along heat exchanger channel 8 and then to the exterior via opening 39 and fan 47. Exterior air is drawn in via fan 44 through opening 46 (either directly from an opening along the side of a window or from a central supply duct), through channel 8 and to the interior via conduit 45.

This arrangement also with four dampers 21-24 allows interior air from the solar collector channels 3 and heat exchange channel 6 to share the same conduits 36, 37 and the same fan 47. Under some circumstances it may be desirable to partially close dampers 21 and 22, allowing air to flow through both the solar collector tubes 3 and the heat exchange channel 6.

Referring next to FIG. 18, interior air is drawn in via conduit 36 to the exterior. Dampers 24 and 21 are blocked to the exterior at opening 38 and to the solar collector channels 3 allowing air to be drawn through heat exchanger channel 6 and exiting through elongated channel 46 directly out an opening in a window or to a central duct. An exhaust fan could either be at conduit 36 or somewhere in the duct after the air has exited the heat exchanger.

Exterior air is drawn through on the other side of the heater (not shown) either directly from outside through a window in a similar way to elongated channel 46 or from a central duct. Fan 44 exhausts the air via conduit 45.

This arrangement with three dampers 24, 21 and 23 allows the solar collector channels 3 and the heat exchanger channel 6 to share the same conduit 36 to exhaust air to the exterior.

Referring next to FIG. 19, exterior air is drawn in via fan 48 to the interior. Damper 24 is blocked to conduit 36 and damper 21 is blocked to collector channels 3 allowing air to flow through heat exchanger channel 8 and out from supply fan 48. Interior air is drawn to the exterior via fan 44, heat exchanger channel 6 and either directly out to an opening in a window via conduit 46 or to a central duct.

This arrangement with three dampers 24, 21 and 23 allows the collector channels 3 and the heat exchange channel 8 to share the same opening 38 to supply exterior air to the interior.

Referring next to FIG. 20, exterior air for the solar collector from opening 38 is drawn through collector channels 3 and exhausted to the exterior again via fan 47. Damper 24 is blocked to conduit 36, damper 22 is partially blocked to both the collector channels 3 and heat exchange channel 6 and damper 23 is blocked to conduit 37. This allows interior air from conduit 45 to also be exhausted via fan 47. The damper box may be made larger to allow for both volumes of air flows. Exterior air for the heat exchanger is drawn in from the upper side either through an elongated conduit 46 directly from an opening in the window or from a central supply duct. This air flow through heat exchanger channel 8 picks up heat from heat exchanger channel 6 and enters the building along the opposite lower side via conduit 49.

In this arrangement of three dampers 24, 22, 23, the solar collector channels 3 and heat exchange channel 6 share opening 39 and fan 47. It is also useful in making it possible for the solar collector to be cooled down in summer while also allowing cool interior air-conditioned air to be used to transfer heat from exterior air in channel 8 which is drawn to the interior. By blocking/unblocking dampers 24 and/or 22, air can flow through either the heat exchange channel 6 or the solar collector channels 3. This arrangement therefore allows for more flexibility.

Referring to FIG. 21, the arrangement described in FIG. 20 also allows for exterior air for the solar collector from opening 38 to be blocked through collector channels 3. In this example, only the heat exchanger is operating. Exterior air for the heat exchanger is drawn in from the upper side either through an elongated conduit 46 directly from an opening in the window or from a central supply duct. This air flow through heat exchanger channel 8 picks up heat from heat exchanger channel 6 and enters the building along the opposite lower side via conduit 49.

Referring next to FIG. 22, exterior air enters via opening 38. Damper 24 is blocked to conduit 36 and damper 23 is blocked to opening 39 allowing exterior air to flow through collector channels 3 and to exit via fan 48 located at the lower end of the unit. In summer, fresh air inlet 38 could be shut allowing air from inside the room to be drawn in through conduit 36, through the collector channels 3. This air from the building may be drawn from under the collector 100, for example through a vent in the floor.

In some of these embodiments the conduits and openings for air to enter or exit the heat exchange unit are positioned laterally or longitudinally along the sides of the unit, or on the front or back face of the base 1. These openings in collector 100 may face the glazing and window frame and may connect directly with openings built into the glazing and window frame. Openings 38 and 39 facing glazing 29 may be used by both solar collector and heat exchanger. In other embodiments conduits 43, 44, 46 and 49 face the interior and conduits 45 and 46 are located on the sides.

Similarly elongated conduits and openings may connect to filters and vents from heat exchange channels 6 or 8 that open to the inside of the building either on the side of the base 1 or to the front facing the inside. However, if there is a requirement to enter or exit a main supply duct for the building which has a circular cross-section, it may be easier to adapt a base 1 inside the heat exchanger 100B to allow for this so that it can more easily be connected directly to this duct. In general, the openings may be positioned in the sides, top, bottom or ends of the collector as is suitable for the design and/or situation of the collector unit.

Table 1 below describes a variety of flow modes which embodiments of the system can operate in.

TABLE 1

| | | | | | Heat exchange - |
|---|---|---|---|---|---|
| Conditions and description | Exterior | Interior | Interior | Exterior | interior air to |
| (with reference to FIG. | air to | air to | air back | air to | interior, exterior |
| 20 except where noted) | inside | exterior | to interior | exterior | air to exterior |
| 1 Positive pressure, solar | ▪ | | | | |
| hours, supply fan | | | | | |
| operating, room temp less | | | | | |
| than heater temp, outside | | | | | |
| temp less than 20 deg C., | | | | | |
| room temp less than 20 | | | | | |
| deg C. | | | | | |
| Exterior air enters via | | | | | |
| opening 38. Damper 24 is | | | | | |
| blocked to conduit 36. | | | | | |
| Damper 23 is blocked to | | | | | |
| opening 39 and damper | | | | | |
| 22 is blocked to conduit 6 | | | | | |
| allowing exterior air to flow | | | | | |
| through collector channels | | | | | |
| 3 and to exit via opening | | | | | |
| 37 and fan 43 located at | | | | | |
| the upper end of the unit. | | | | | |
| 2. Balanced pressure, | | | ▪ | | |
| solar hours, supply fan | | | | | |
| operating, room temp less | | | | | |
| than heater temp, outside | | | | | |
| temp less than 5 | | | | | |
| Interior air enters via | | | | | |
| opening 36. Damper 24 is | | | | | |
| blocked to conduit 38. | | | | | |
| Damper 23 is blocked to | | | | | |
| opening 39 and damper | | | | | |
| 22 is blocked to conduit 6 | | | | | |
| allowing interior air to flow | | | | | |
| through collector channels | | | | | |
| 3 and to exit via opening | | | | | |
| 37 and fan 43 located at | | | | | |
| the upper end of the unit. | | | | | |
| 3. Balanced pressure, | | | | | ▪ |
| supply and exhaust fan | | | | | |
| operating, usually non- | | | | | |
| solar hours, room temp | | | | | |
| greater than heater temp, | | | | | |
| outside temp less than 5 | | | | | |
| Exterior air enters via | | | | | |
| opening 46 on the upper | | | | | |
| side(s). Damper 24 is | | | | | |
| blocked to conduit 38. | | | | | |
| Damper 23 is blocked to | | | | | |
| opening 37 and damper | | | | | |
| 22 is blocked to collector | | | | | |
| channels 3 allowing | | | | | |
| exterior air to flow through | | | | | |
| channel 8 and to exit via | | | | | |
| opening 49 on the lower | | | | | |
| side(s) and fan. Interior air | | | | | |
| enters via opening 45 | | | | | |
| allowing interior air to flow | | | | | |
| through channel 6 and to | | | | | |
| exit via opening 39 and | | | | | |
| fan 47. | | | | | |
| 4. Positive pressure from | ▪ | | | | ▪ |
| solar and heat exchange, | | | | | |
| supply and exhaust fans | | | | | |
| operating, solar hours, | | | | | |
| room temp less than | | | | | |
| heater temp, heater temp | | | | | |
| greater than outside temp, | | | | | |
| outside temp greater than | | | | | |
| 5 but less than 20, heater | | | | | |
| greater than 20 | | | | | |
| In this mode the air for | | | | | |
| channel 6 is also sourced | | | | | |
| from the sides or | | | | | |
| embodiment in FIG. 17 is | | | | | |
| used with an extra damper | | | | | |
| 21 as described below: | | | | | |
| Exterior and interior air | | | | | |
| enters via opening 38 and | | | | | |
| 36. Damper 24 is partially | | | | | |
| blocked to conduit 36. | | | | | |
| Damper 21 is partially | | | | | |
| blocked to conduit 6. | | | | | |
| Damper 22 is partially | | | | | |
| blocked to collector | | | | | |
| channels 3. Damper 23 is | | | | | |
| blocked to opening 37 | | | | | |
| allowing interior and | | | | | |
| exterior air to flow through | | | | | |
| collector channels 3 and | | | | | |
| conduit 6 and to exit via | | | | | |
| opening 39 and fan 47. | | | | | |
| Interior air enters via | | | | | |
| opening 45 allowing | | | | | |
| interior air to flow through | | | | | |
| channel 6 and to exit via | | | | | |
| opening 39 and fan 47. | | | | | |
| 5. Balanced pressure from | ▪ | | | | ∘ |
| solar and one exhaust | | | | | |
| channel from heat | | | | | |
| exchange, supply and | | | | | |
| exhaust fan operating, | | | | | |
| solar hours, room temp | | | | | |
| less than heater temp, | | | | | |
| heater temp greater than | | | | | |
| outside temp, outside | | | | | |
| temp greater than 5 but | | | | | |
| less than 20, heater | | | | | |
| greater than 20 | | | | | |
| This mode would require | | | | | |
| an embodiment whereby | | | | | |
| heat exchange channels 6 | | | | | |
| and 8 supply and exhaust | | | | | |
| air independently from the | | | | | |
| collector. For example, | | | | | |
| openings 46 and 49 allow | | | | | |
| air to flow through channel | | | | | |
| 8 and openings elsewhere | | | | | |
| such as other sides allow | | | | | |
| a cross or transverse air | | | | | |
| flow through channel 6 | | | | | |
| In this embodiment only | | | | | |
| two dampers are required | | | | | |
| for the collector, one at | | | | | |
| either end. | | | | | |
| 6. Negative pressure, fan | | ▪ | | | |
| not operating, solar hours, | | | | | |
| outside temp greater than | | | | | |
| 20, room temp greater | | | | | |
| than 20, heater greater | | | | | |
| than 21 | | | | | |
| Exterior air enters via | | | | | |
| opening 36. Damper 24 is | | | | | |
| blocked to conduit 38. | | | | | |
| Damper 23 is blocked to | | | | | |
| opening 37 and damper | | | | | |
| 22 is blocked to conduit 6 | | | | | |
| allowing exterior air to flow | | | | | |
| through collector channels | | | | | |
| 3 and to exit via opening | | | | | |
| 39 and fan 47. | | | | | |
| 7. Negative pressure, | | ▪ | | | ▪ |
| supply fan not operating, | | | | | |
| solar hours, outside temp | | | | | |
| greater than 20, room | | | | | |
| temp less than 20, heater | | | | | |
| temp greater than 28 | | | | | |
| This mode would require | | | | | |
| independent operation | | | | | |
| between the solar | | | | | |
| collector (with one damper | | | | | |
| only at either end) and the | | | | | |
| heat exchanger channels | | | | | |
| 6 and 8. | | | | | |
| 8. Positive pressure, | ▪ | | | | |
| supply fan operating, non- | | | | | |
| solar hours, outside temp | | | | | |
| less than 20, room temp | | | | | |
| greater than 21 | | | | | |
| Same as 1 | | | | | |
| 9. Positive pressure, | ▪ | | ▪ | | |
| supply fan operating, solar | | | | | |
| hours, outside temp | | | | | |
| greater than 5 but less | | | | | |
| than 15, inside temp | | | | | |
| greater than 18, damper | | | | | |
| at air intake partially open | | | | | |
| so that air sourced from | | | | | |
| outside and inside. | | | | | |
| Exterior and interior air | | | | | |
| enters via openings 38 | | | | | |
| and 36. Damper 24 is | | | | | |
| partially blocked to conduit | | | | | |
| 36. Damper 23 is blocked | | | | | |
| to opening 39 and damper | | | | | |
| 22 is blocked to conduit 6 | | | | | |
| allowing interior and | | | | | |
| exterior air to flow through | | | | | |
| collector channels 3 and | | | | | |
| to exit via opening 37 and | | | | | |
| fan 43. | | | | | |
| 10. Negative pressure with | | ▪ | | ▪ | |
| combined trickle | | | | | |
| ventilation and fresh air to | | | | | |
| cool the heater, no fans, | | | | | |
| solar hours, outside temp | | | | | |
| greater than 20, room | | | | | |
| temp greater than 20 and | | | | | |
| solar heater temp greater | | | | | |
| than 65, supply damper | | | | | |
| partially open | | | | | |
| Interior and exterior air | | | | | |
| enters via opening 38 and | | | | | |
| 36. Damper 24 is partially | | | | | |
| blocked to conduit 36. | | | | | |
| Damper 23 is blocked to | | | | | |
| opening 37 and damper | | | | | |
| 22 is blocked to conduit 6 | | | | | |
| allowing interior and | | | | | |
| exterior air to flow through | | | | | |
| collector channels 3 and | | | | | |
| to exit via opening 39 and | | | | | |
| fan 47. | | | | | |
| 11. Heater is self-cooling | | | | ▪ | ▪ |
| and heat exchanger fans | | | | | |
| are operating, solar hours, | | | | | |
| outside temp greater than | | | | | |
| 20, room temp less than | | | | | |
| 21, solar heater greater | | | | | |
| than 80 | | | | | |
| Exterior air enters via | | | | | |
| opening 38. Damper 24 is | | | | | |
| blocked to conduit 36. | | | | | |
| Damper 23 is blocked to | | | | | |
| opening 37 and damper | | | | | |
| 22 is partially blocked to | | | | | |
| conduit 6 allowing exterior | | | | | |
| air to flow through | | | | | |
| collector channels 3 and | | | | | |
| interior air to flow through | | | | | |
| channel 6 and to exit via | | | | | |
| opening 39 and fan 47. | | | | | |

### Heat Storage

As is described above, in many embodiments a heat exchanger 100B may be incorporated into the housing 1 of the collector 100. In some cases the upper layer of insulation 4 between the solar energy collecting portion 100A and the heat exchanger 100B is configured to be removed (and, if desired, replaced), leaving a cavity that can instead be filled with heat storage material such as a phase change material (PCM), as is described further below. In other cases, for example where an increase in the depth of the collector 100 can be accommodated, heat storage material 51 can be stored under the solar energy receiving portion 100A in addition to retaining the upper insulating layer 4, as illustrated in FIG. 7. The purpose of this is to store solar heat energy so as to extend solar heat gain during cloud cover or at the end of the day when less solar energy is incident on the solar energy collecting portion 100A. The heat storage material 51 is preferably positioned in close proximity to the heat exchanger 100B so that excess interior heat can also be stored and transferred to exterior air. Where ventilation is not the primary concern the entire space under the solar energy collecting portion may be used to store heat, rather than housing the heat exchanger 1006.

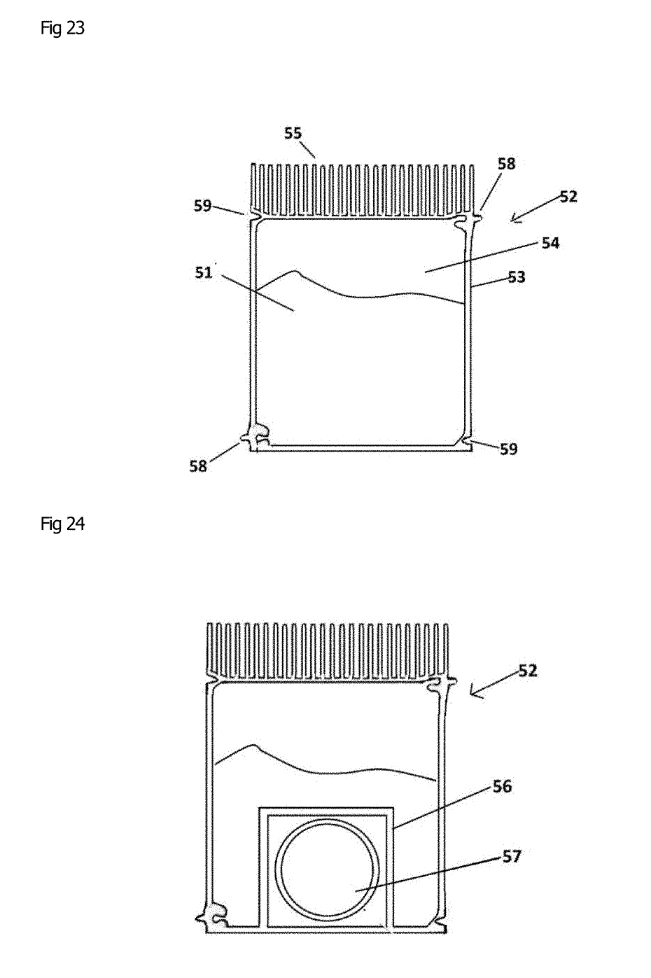

Referring next to FIG. 23, a heat storage member 52 comprises an extrusion 53 which defines a chamber 54. The heat storage member further comprises a fin structure comprising a plurality of fins 55. In some embodiments the heat storage member may further define an internal compartment 56 through which a fluid conduit 57 may pass. In one embodiment the fluid conduit 57 may comprise, or may be in fluid communication with, heat exchange channel 8. In another embodiment the fluid conduit 57 may contain water.

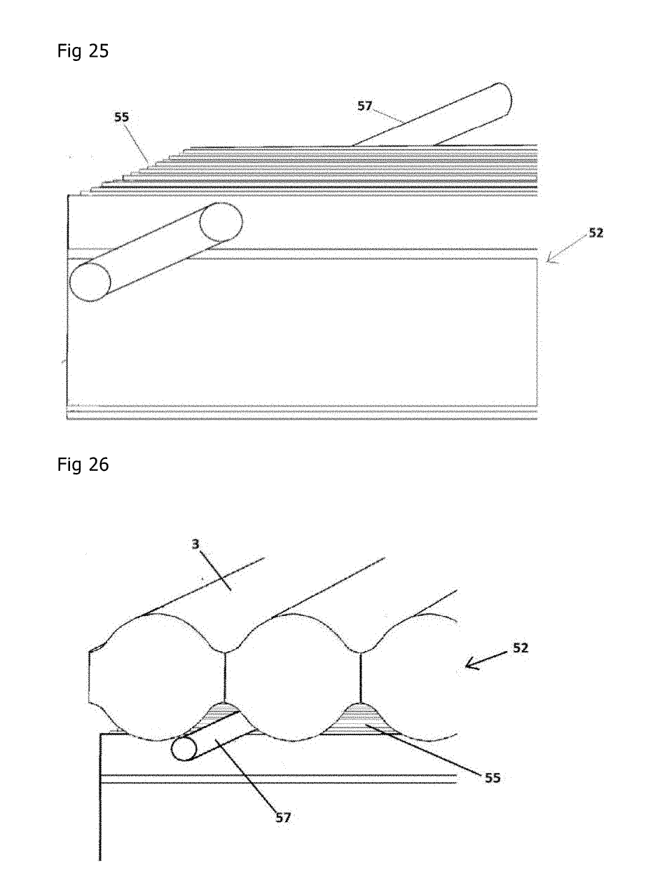

Referring next to FIGS. 24 and 25, a heat storage member 52 is shown which is similar to that shown in FIG. 23, but having a fluid conduit 57 in direct thermal contact with the fins 55 of the fin structure. In the embodiment shown the fluid conduit 57 may comprise, or may be in fluid communication with, heat exchange channel 8.

FIG. 25 shows heat storage member 52 similar to that shown in FIG. 24 with a fluid conduit 57 positioned above and in thermal contact with the fins 55 thereof, and with a plurality of air channels, for example collector channels 3, positioned above the extrusion heat storage member 52 and in thermal contact therewith.

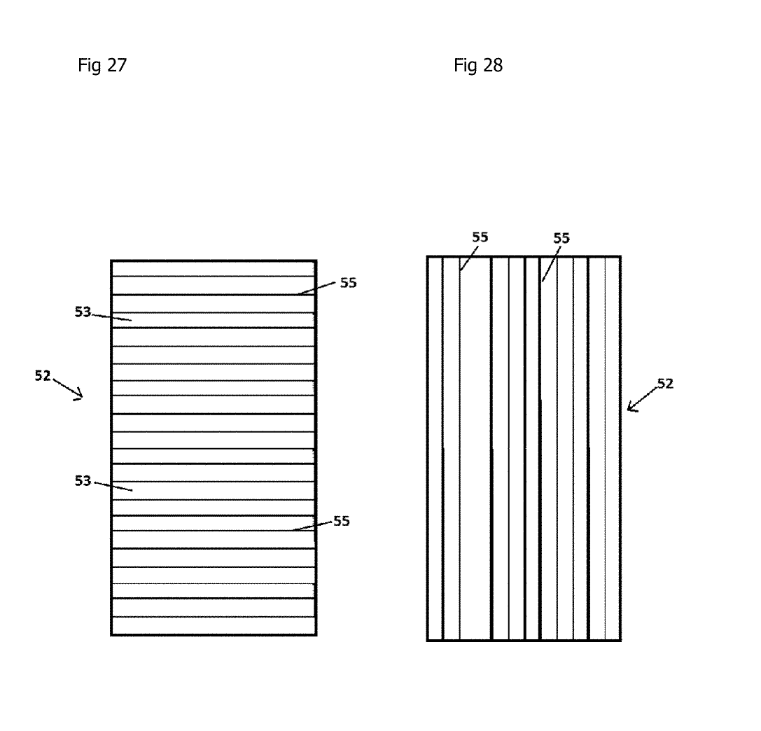

FIG. 26 shows a heat storage member 52 comprising a plurality of extrusions 53 coupled together, for example by interlocking, adjacently with the fins 55 in a transverse orientation relative to the direction of air channels mounted above the fin structure. FIG. 28 shows a similar embodiment to FIG. 27, but with the fins 55 orientated longitudinally, substantially parallel to the air channels.

In embodiments of the invention the fins 55 extend from an exterior of the heat storage member 52 thus improving heat exchange to the surroundings.

The choice of high heat transmission material (for example aluminium) for the walls of the heat storage member and fins, as well as the use of male and female interlocking members 58, 59 (best seen in FIG. 26), all contribute to creating a heat sink for the heat storage material which then transmits the stored heat evenly across the entire array of chamber and fin extrusion members. The chambers 54 containing the heat storage material 52 can be arranged side by side as in the embodiments in FIGS. 27 and 28. These can be arranged either longitudinally or transversely underneath the collector channels 3 of the solar energy collecting portion 100A. If wax or any fluid material is used as a heat storage material, then transversely arranged chambers may be preferred in order to avoid the problems arising from the material flowing to the bottom of longitudinal chambers, since the collector 100 is usually mounted on a tilt for maximum solar irradiance. Another advantage of transversely arranged chambers is that pipes carrying water, also contributing to heat storage and itself being heated by the sun for use, may be more easily incorporated into or thermally coupled to the fins. For example water may be piped through fluid conduit 57 in the embodiments shown in FIGS. 24 and 25, the water thereby being in thermal contact with the fins 55. Water pipes may alternatively be recessed under the collector channels 3, for example those described in the collector from PCT Publication No PCT/NZ2013/000185, while also in contact with the top of the fins. In general, water pipes may be anywhere in proximity and thermally coupled to the chambers and fins with the objective of contributing to heat storage and to being heated themselves.

### Control System

Since, in some embodiments, movement of a single damper at each end of the collector 100 enables the system to switch between modes, the control system for embodiments of the present invention may be simplified compared to that for earlier systems (e.g. that described in US Patent Publication No US2004/0237460). In some embodiments, the dampers and (or) fans are automatically controlled by an intelligent system switching between modes as required. For example, the system may be configured to respond to the temperatures in the heater, and/or ambient temperature and/or the temperature inside the building, or alternatively to a pressure gauge inside as detected by one or more sensors. In one embodiment, a central processor receives such information from the sensors and determines which mode of operation the system will operate in based on the information detected and rules of operation which are stored in a data storage device able to be accessed by the processor. The processor controls the dampers and fans to operate based on the mode of operation determined to be applicable based on the predetermined rules and the sensed parameters. It will be appreciated that the rules may be altered or set as desired and dependent on a number of factors, such as the way in which the system is intended to operate, the function it is intended to perform (e.g. cooling, heating, ventilation, or any one or more of these) and any particular requirements of a given installation which may be affected by, for example, weather patterns, location, altitude, etc. Examples of the parameters monitored and flow modes used are given above.

Power Generation from Air Speed

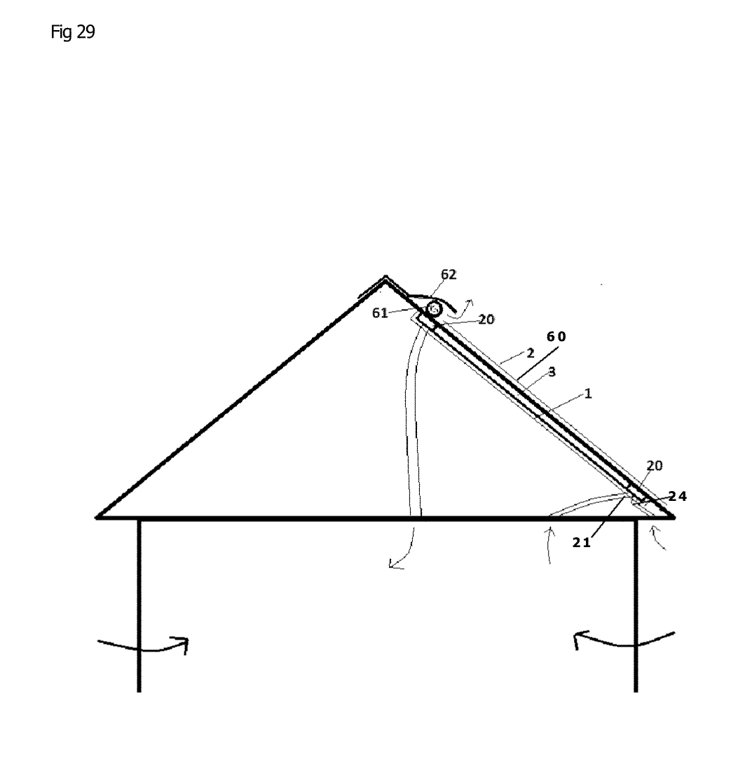

Initial test results on passive air syphoning show a close correlation between air speed and heat generated inside the solar energy receiving portion. This air movement can be used to generate power, for example during summer cooling or self-cooling modes. The test was carried out on the ground. It is expected that increasing the height of the collector above the ground to create a ‘chimney effect’ or updraft which will further increase the speed of air flowing through the collector. Referring next to FIG. 29, the air flow caused by thermal syphoning may also be useful when in combination with photovoltaic (PV) panels 60 to help cool them down, thus increasing their efficiency. The solar energy receiving portion 100A could be positioned above the PV panels such that air entering the collector channels 3 first flows over a surface of the PV panels, for example the lower surface. Alternatively the solar energy collecting portion 100A may be located directly below the PV panels such that air exiting the collector channels 3 flows over the PV panels. In addition or alternatively, a solar collector 3 with damper boxes 20 at either end and housing 1 can be integrated into the roof under glazing 2 or PV panel 60 as in FIG. 31 such that air may be sourced from outside under the eave using damper 24 or from the interior using damper 21. Air flowing through solar collector 3 can exit into conduit 61 under flashing 62 or be redirected to the interior by damper 23.

The speed of the air flow may be sufficient to also generate power. The air flowing from thermal syphoning through the solar energy receiving portion 100A may feed into one of more conduits which are provided with suitable power generation means (typically a turbine, for example a fan 61 described further below, connected to a generator) to generate power from wind energy. This moving air could either exit horizontally, vertically or at any angle.

In one embodiment a vertically orientated conduit, for example conduit 35 shown in FIG. 14, may be provided with a suitable power generation means such as a turbine connected to a generator. In this embodiment the air from the collectors on the different levels in a building column can be carried up by the conduit 35. Uses of this could be to generate electricity from air movement, but also space heating a pool or sauna, growing plants, drying clothes or products in the upper floor of the building for example.

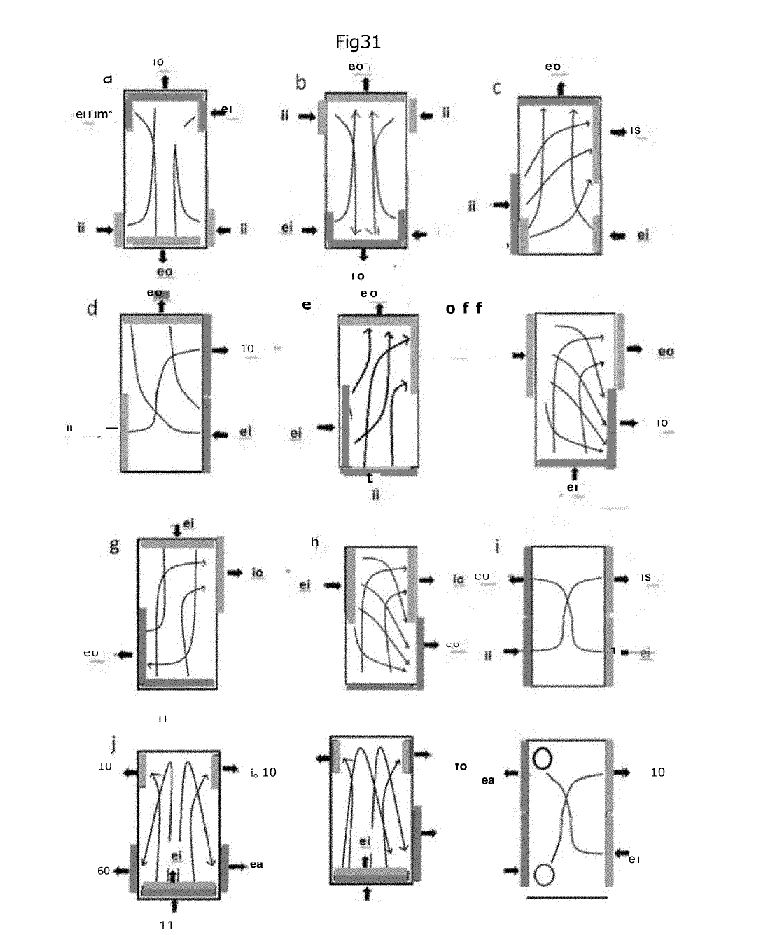

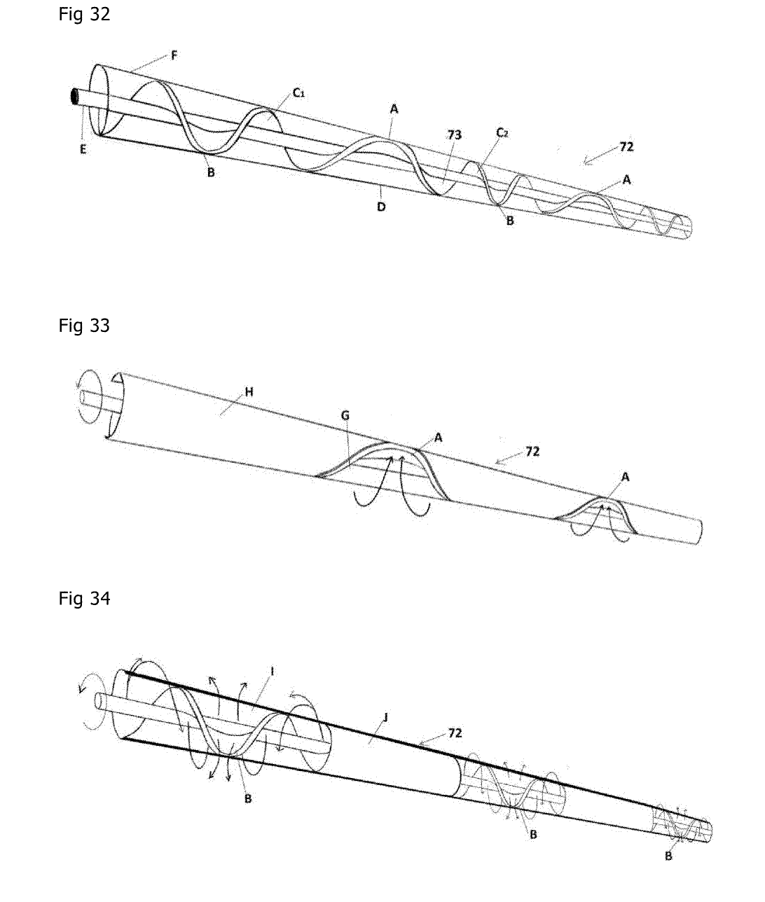

In another embodiment in FIG. 29 a conduit 61 may be connected to a damper box 20, such that air enters into conduit 61 where it turns a fan which in turn generates power. This fan is described in FIGS. 32 to 40.

Factors affecting air speed in the solar energy collecting portion include temperature differential between the air inside the solar energy collecting portion and the air outside, as well as the height of the solar energy receiving portion. Upscaling the size of the solar energy collecting portion both in length and width, increasing dimensions of the turbulent design tubes and helix would also help to maximise air speed to generate power.

### Heat Pump

Another potential beneficial off-shoot of air movement caused by passive thermal syphoning is when the resulting updraft causes a fan to act as a turbine and passively drive a heat pump (and or/a generator).

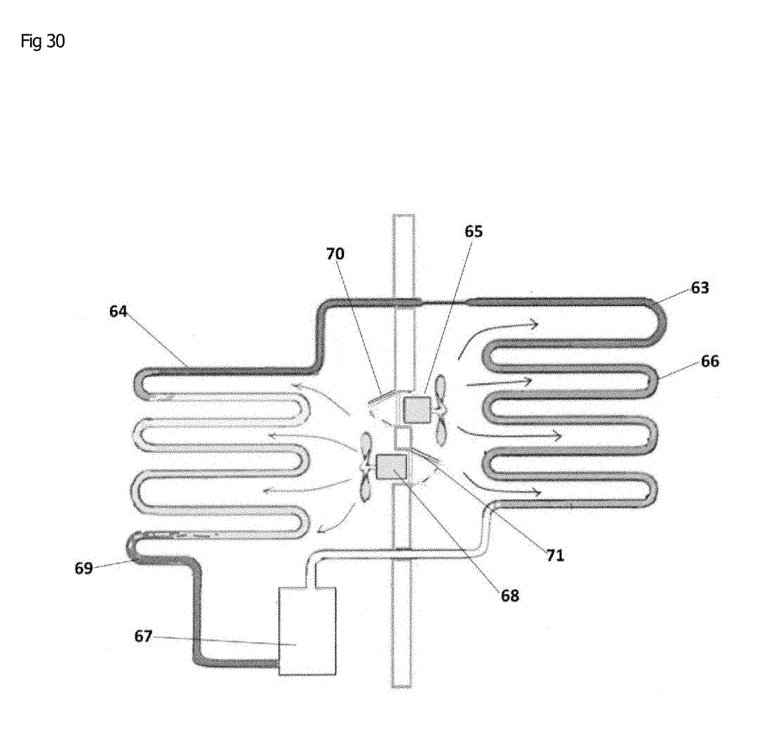

FIG. 30 shows a basic split heat pump air conditioning system 66 with an evaporator unit 63 and condensing unit 64. A fan 65 blows air through the evaporator coil 66 and transfers the heated or cooled air into the building. The condensing unit 64 with compressor 67 and fan 68 moves heat by compressing refrigerant and pumping it through the condenser coils 69.

In one embodiment of this invention, fans 65 and/or 68 can connect inside to outside when dampers 70 or 71 are opened. For example, when damper 70 is open and damper 71 is closed fan 65 may be powered by thermal syphoning via a solar air heater. The hotter the solar air heater becomes in relation to the outside air temperature the more air should be drawn through from thermal syphoning. When damper 71 is open and damper 70 closed, fan 68 may allow positively pressured heated air from a solar air heater to be expelled, thus further boosting the heat. When dampers 70 and 71 are closed then fan 65 and fan 68 may revert to recycling stale air. The dampers can be of any type such as butterfly dampers or may be electrically operated.

### Flow Modes Through Heat Exchanger

Most of the embodiments in FIGS. 16 to 22 require the solar energy collecting portion and heat exchanger to be used at different times, such as the solar collector during solar hours and the heat exchanger during non-solar hours or when the ambient is very cold or hot. This is apparent in Table 1 listing conditions 4,5,7 and even 11 that determine the mode. However, in some circumstances it is beneficial for both solar energy collecting portion and heat exchanger to be operating simultaneously in which case the conduits and openings should be separate. In this case only dampers 24 and 23 in FIGS. 16 to 22 would be required at either end of the solar collector along with openings 28, 36, 39 and 37. The heat exchanger would require two openings for channel 8 such as 46 and 49 in FIG. 20 and another two openings for channel 6. The heat exchanger may still share the same housing as the solar collector. The location of these openings and conduits in the heat exchanger determines the direction of cross or counter flow movement within channels 6 and 8 with the objective to maximise heat transfer between channels 6 and 8.

FIGS. 31a-l illustrate many possible locations for the entries and exits for exterior and interior air in a flat plate heat exchanger with first and second channels 6 and 8 contained in an insulated base 1, as well as a variety of directions of the air flows through the channels 6, 8. The layout of the heat exchanger channels 6 and 8 and the conduits to these chambers will also depend on the preferences of location and arrangement for the removal of interior air or introduction of exterior air to the interior. For example, it will be depend on whether provision is made for air to enter and exhaust from the same floor or whether the air feeds into a multi-floor system. In general the objective is to optimise the transfer of heat between the air flows in the first and second heat exchanger channels 6, 8 and to circulate aft in the building to prevent stratification of heat.

Referring to FIG. 31a, ‘ei’ (exterior air in) enters second heat exchange chamber 8 the top sides, either through vents in a window frame, a wall, or from a central supply pipe. Heat is exchanged between the first and second heat exchange channels 6, 8 and ‘ea’ (exterior air out) enters the interior at the lower end of the heat exchanger.
‘ii’ (interior air in) enters the first heat exchange channel 6 from the lower front corners or from the sides and transfers its heat to second heat exchange channel 8. ‘io’ (interior air out) is then exhausted to the outside at the top.

In the embodiment of a heat exchanger in Ag 31a, the heat exchanger unit can share one of the fans used by the solar energy collection portion 100A, for example at opening 25 (see FIG. 1). This arrangement allows good coverage and contact between chambers 6 and 8, especially when baffles are included to encourage air to spread across the entire surfaces.

It is advantageous to remove stale air from the lower part of the room which would displace heat that tends to stagnate to the top in a building. This is the case in Ag 31a, On the other hand, the lower air would be cooler and may not exchange as much heat with the interior air as if it was being drawn from the upper end.

FIG. 31b—

This is the reverse of FIG. 31a heat exchanger air flows. ‘ei’ enters the heat exchanger at the lower sides of chamber 8 and exhausts ‘eo’ at the top to the interior. ‘ii’ enters at the upper sides of chamber 6 and ‘io’ exhausts to the exterior at the bottom opening.

FIG. 31c—
‘ei’ enters the second heat exchanger chamber 8 from both sides at the lower end and ‘eo’ is expelled to the interior through an opening at the upper end.
‘ii’ enters the first chamber 6 from the lower end of one side and ‘io’ is expelled at the upper end of the other side to the outside.
   FIG. 31d—

Ex and eo—Exterior air ‘ei’ enters second heat exchange chamber 8 on one lower side and ‘co’ exits the first heat exchanger chamber 6 at the top end. Dampers open allowing a fan at opening 37 (see FIG. 1) to draw air into the home.

This may not be ideal because the air would need to do a 360 degree turn to be drawn out.

Alternatively, air could be drawn to one end of the damper box (for example as shown in FIG. 8) where it would be directly expelled to the interior. This may require another damper.

li and io Interior air ‘ii’ enters the second chamber 8 from one lower side and is expelled at the upper opposite side. This air flow would require its own fan.

FIG. 31e—

‘ei’ enters the first chamber 6 on one lower side and exits at the upper opposite side.

‘ii’ enters second chamber 8 via an opening and exits to the exterior at one upper side.

In this case there the air may have more difficulty dispersing over the entire area in chambers

6 and 8 as it would be inclined to take the path of least resistance and leave out some corners.

This could be mitigated by baffles as described above. It is also disadvantageous in that the two air flows are not moving in counter-flow so there may not be a good uptake of heat. However, this example does have its benefits in removing interior air from lower down thus displacing air that stagnates under the ceiling.

### FIG. 31f

‘ei’ enters the first chamber 6 via an opening at the lower end and ‘eo’ exits to the interior at one upper side. A fan at eo could draw the air through.

‘ii’ enters the second chamber 8 from one upper side and is exhausted outside at the opposite lever side.

In this case exterior air enters the heat exchanger from outside and interior air is removed to the outside from the lower half of the room. Only the air in the upper half of the room is being circulated by exterior air entering and interior air exiting. This may not be ideal.

### FIG. 31g

ei and eo—Exterior air ei enters the first chamber 6 when damper 22 is open and damper 23 is closed (see FIG. 1). It exits into the interior on one or both lower sides.

li and io—Interior air ii enters chamber 8 via an opening and exits on one or both upper sides.

In this case, there is good coverage between the first and second chambers 6 and 8 especially if exterior air is brought in on both lower sides and interior air is exhausted on both upper sides. Also, interior air being removed from the lower end will help to circulate air in the building.

### FIG. 31h

ei enters the first chamber 6 on the upper side and is drawn to the interior on the lower opposite side.

ii enters second chamber 8 through an opening and exits on one upper side.

In this case there is reasonable coverage between first and second chambers 6 and 8. Stale air is removed from the bottom and fresh warmed air is introduced at the top which is good for circulation. The only issue here is that it cannot use the same fan as the solar air heater.

### FIG. 31i

ei enters the first chamber 6 on one lower side and exits on the opposite upper side. ii enters second chamber 8 through one lower side and exits the opposite upper side.

In this case, no fans or dampers would be shared with the solar energy collecting portion. However, the advantage of this arrangement would be a good coverage between two heat exchanger chambers. It also means the intake of exterior air and the exhaust of interior air will be along one side and may work well when connected to vents in a window.

FIG. 31j both interior and exterior air flows enter at the lower end. lo exits on both upper sides and eo exits on both lower sides.

In FIG. 31k both interior and exterior air flows enter at the lower end and exit on the sides. lo exits on both upper sides and eo exits on one side.

In FIG. 31l the intake of exterior air and the expelling of interior air is by means of spigots on the face of insulating housing 1.

Generally speaking it is advantageous to work with what air naturally will do. Therefore, as heated air rises and cool air drops, the preferred options would be to source interior air (ii) from lower in the heat exchanger unit and exterior air (ei) from the upper part of the unit. FIGS. 31a, 31g and 31h are examples of this.

These are some examples but there are other combinations and locations of fans and dampers driven either electrically or via thermal syphoning within a heat pump coupled with solar air heating/cooling system.

### Fans

FIGS. 32-40 show a fan, generally referenced by arrow 72, which may be particularly suited for use with or as part of the collector and/or heat exchanger of the present invention.

FIG. 32 shows a tube F in outline. A blade 73 is provided within the tube. The tube wall is provided with openings (not shown in FIG. 32) as is described further below.

The blade 73 is connected to a cylindrical central portion E all along the axis and may extend to the outer edges in close proximity to the inside of the tube F in order to prevent leakage when central portion ‘E’ rotates about its longitudinal axis. In a traditional auger, fluids are transferred along in one direction an axis. However, in this example, air flows on either side of portion ‘A’ where portions ‘C1’ and ‘C2’ extend out from portion ‘A’ in the form of two substantially helically shaped auger portions of opposite chirality.

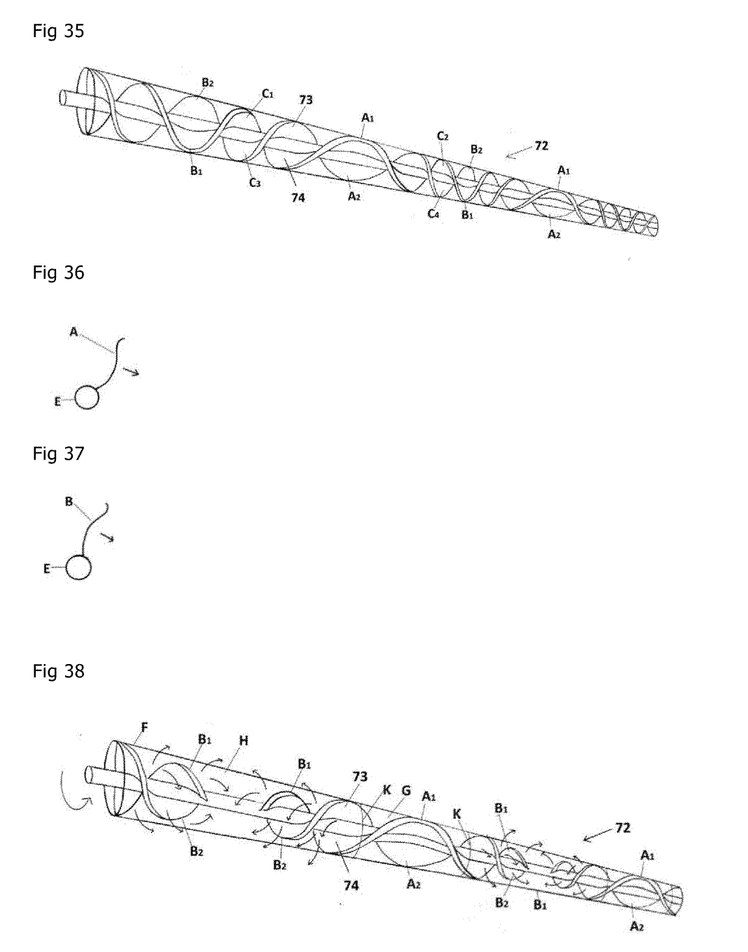

As shown in FIG. 33, opening ‘G’ follows the contour of blade portion ‘A’ but its shape and size would depend on the number of blades as described later in FIGS. 35 and 38. ‘Blade portion A’ pulls air in from one side to the other when central portion ‘E’ rotates clockwise.

Referring next to FIG. 34, tube section ‘J’ blocks intake of air from ‘A’ on the other side, thus avoiding regurgitation and inefficiencies. Air drawn in with blade portion ‘A’ is instead transferred along both directions of central portion ‘E’. Tube section ‘H’ in FIG. 35 blocks air from flowing back out again, also avoiding regurgitation. Opening allows air from one side of the axis to be exhausted out the other side. Depending on the amount and force of air flow generated by rotating blade portion ‘A’, air is exhausted directly to the other side as well as in a spiralling motion to the back of blade portion ‘B’ where any remaining air flow collides with air flowing the opposite direction. Blade portion ‘B’ expels the rest. The number of turns in the auger portion ‘C’ can be added or deleted as required. In some embodiments blade portion ‘A’ can transition directly to blade portion ‘B’ without any twists in between. Regarding the length of blade portion ‘A’ in relation to the remainder of the blade, two factors should be taken into account to equate the spacing requirements. Firstly, blade portion ‘A’ is propelling air in two directions and so is larger in some embodiments. In addition, air will be expelled both directly out the opening ‘I’ as well as spiralling around blade portion ‘C’ until it exits at blade portion ‘B’.

Preferred embodiments of the fan 72 may be manufactured using additive manufacturing processes (3D printing).

Unlike the standard cross-flow blades, the fan 72 shown in FIGS. 32-40 minimizes space between the periphery of the curved blades and the inside wall of the tube F without constricting its rotational movement. This is especially important for blade A where air is drawn in. In this way air is prevented from leaking back and the advantage of minimizing the overall width compared with a standard version is achieved.

FIG. 35 shows how multiple blades can be added. In this example, one more blade 74 is added to blade 72 such that blade portions A and B are actively drawing in and expelling air at all times. Additional blades can also be added.

FIG. 36 is a cross sectional view through the centre of blade portion A connected to axis E and shows one way to shape the blade in such a way to draw air in. The part of the blade closest to the axis is convex in the direction of rotation in order to cause less resistance. The outer part of the blade is concave in the direction of rotation in order to direct air along C1 and C2. The proportion of convex can lessen and proportion of concave increase on either side of the centre of the blade to optimise air intake. Portion ‘A’ can be elongated in relation to the rest so as to account for the amount of air divided when transferred in both directions.

FIG. 37 is an embodiment of blade portion ‘B’ and shows a cross sectional view through the centre of B connected to axis E, functioning here to expel air. Its lower section is concave and the greater proportion of the upper section convex in the direction of air flow so as to expel air.

FIG. 38 is a preferred embodiment with multiple blade portions A(i). In this example, blade portions A1 and A2 extend fully to the inner side of tube F. They form circular helixes to prevent regurgitation of air and encourage air to flow along the blades. The cross section through the centre blade portion A with axis E may be like that of FIG. 38. Moving along the blades on either side of this centre, the convex root progressively lessens and the concave outer edge increases in size in order to direct air flow to the outer ends of blade portion A1 and A2. Opening G in tube F which extends to edges K allows air to be pulled in along the front face of the axis via blade portions A1 and A2.

In contrast, blade portions B1 and B2 are conic helixes because the outer edges of the blade portions narrow to a point somewhere along the axis. Instead of a continuous helix as shown in FIG. 35, there is now a gap between sequences of blade portions B1/B2, A1/A2 and B1/B2. Tube section H blocks air along the front face extending to edges K. Opposite opening I allows air to flow to the back face of the axis. Tube section H is shown here as transparent for the purposes of showing blade B1 and B2. The advantage of a conic helix is that it allows more even distribution of air being propelled to the other side of the axis via opening I from blade portions B1 and B2. Air is prevented from being pulled back to the front face of the axis since the tail ends of the helixes move with the direction of rotation, thus preventing any drag or resistance. In general this design maximizes both 1) air intake along blade portions A(i) from opening G and, 2) expelling of air along blade portions B(i) from I.

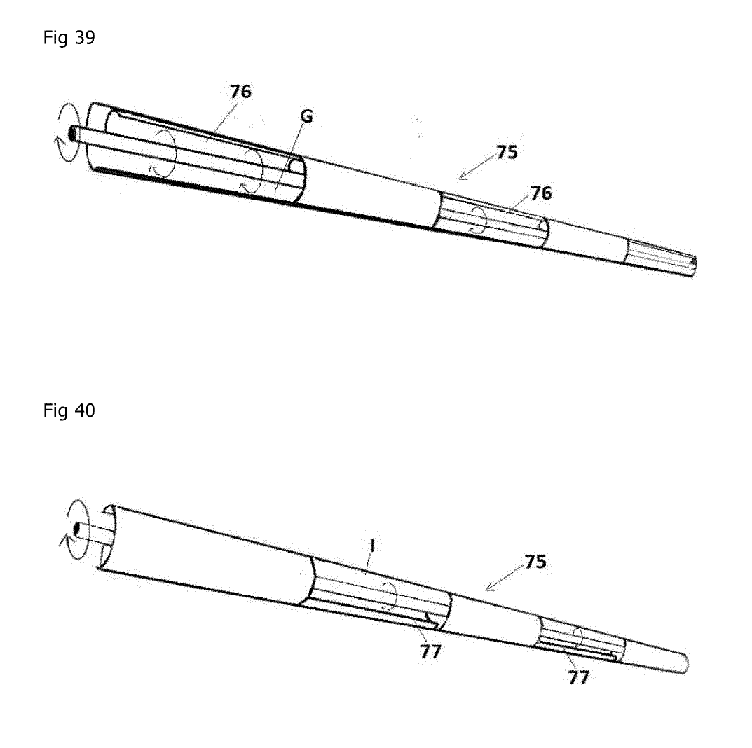

A fan 75 with an alternative type of blade 76 is shown in FIG. 39. In this example one or more curved blades 76 are provided. The blades have a concave pressure face and may overlap. The blades may also slightly twist around axis E. This may be preferable in so far as it helps to funnel air along blade portions 76 and 77. An opening ‘G’ is provided. Tube section ‘J’ blocks leaking of air, and the curved blade(s) draw in air and direct it towards both ends and openings ‘I’. On either side of blade 76, one or more back-curving blades 77 having a convex pressure face drive the air out the other side of the axis as shown in FIG. 40. Again tube section ‘H’ blocks the air from leaking back out and opening T allows the air to flow from one side of the axis to the other.

Another alternative (not shown) is an auger blade that twists in one direction only with blocked alternate opposite side sections allowing air to be in turn pulled through from one side and expelled to the other. The preferred options however are described in FIGS. 32-38 because the curved blades around the axis is expected to be more effective to drive the air towards opening ‘I’ than a one-directional auger. The shape of the blades will also be influenced by whether they rotate by mechanical means or from thermal syphoning/updraft caused by the substantial difference in temperature between inside the collector 3 and outside the collector 3. This is the case with the embodiment shown in FIG. 29 where air movement from thermal syphoning via collector 3 causes fan 61 to rotate as a means of generating power. In this example, the objective at blade portion A is to form a sail-like blade shape that ‘catches the wind’ and causes the blade to rotate in the direction of air movement. It is also important that there are multiple blades A(i) as shown in FIGS. 35, 38, 39 and 40 so that the rotation does not lose momentum as the blades rotate to the other side.

In general the emphasis in the design of the blades for the purposes of generating power is to efficiently turn the axis, whereas the emphasis in the design of the mechanically driven fan in the application of the heat exchanger, for example, is to efficiently drive a maximum quantity of air along from one side of the axis to the other. A collector integrated into a roof as shown in FIG. 29 can also function in all the modes already described, such as a heater in winter. However, this embodiment allows excess heat in summer to be used to generate power. Other embodiments may use heat created under photovoltaic panels to turn the fan as a power generating source. The collector can also be upsized and installed on a hillside or building with the purpose of generating power.

In general the objective of the invention is to create a slimmer fan than the standard version. It is well suited in the context of a solar collector, heat exchanger and even as a means of generating power, shown as 61 in FIG. 29. The invention consists of a blade or blades that function to pull air from one side of the axis to the other side by selectively blocking opposite alternate sections of the sides. The blade is shaped to maximize the amount of air flowing to the other side and transfer it in the direction of alternate opposite openings at section(s) T. The opposite side of opening(s) 1′ is also blocked to prevent back-flow of air, thus preventing inefficiencies.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavor in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Aspects of the present invention have been described by way of example only and it should be appreciated that modifications and additions may be made thereto without departing from the scope thereof as defined in the appended claims.

I claim:

1. A solar heat collector comprising:
a plurality of upper air channels arranged adjacently;
means for exchanging heat energy with the plurality of upper air channels positioned underneath the upper air channels and in thermal communication therewith;
a first flow control means provided at a first end of the upper air channels and a second flow control means provided at a second end of the air channels, each flow control means movable between a first position in which flow through the upper air channels is substantially prevented and a second position wherein flow though the upper air channels is permitted;
characterized in that
when in the second position, each flow control means substantially prevents fluid flow through a respective further conduit or opening;
each flow control means is moveable to a third position wherein flow through the upper air channels is permitted, and flow though the further conduit or opening is also permitted;
the flow control means comprises an elongate blade which is rotatable about a longitudinal axis.

2. The solar heat collector of claim 1 wherein, the plurality of upper air channels is in fluid communication with a fan having a rotor rotatable mounted within a housing, the rotor comprising at least one blade extending along a longitudinal axis, wherein the longitudinal axis is axially aligned with the longitudinal axis of the elongate blade of the flow control means.

3. A heat exchanger comprising:
a body, a first heat exchange channel and a second heat exchange channel in thermal contact with the first heat exchange channel, wherein at least one of the first and second heat exchange channels is provided with a plurality of cylindrical or conical bosses
in combination with a solar heat collector of any one of claim 1 or 2.

4. The heat exchanger of claim 5 wherein
at least one of the first and second heat exchange channels is in fluid communication and axially aligned with a fan having a rotor rotatable mounted within a housing, the rotor comprising at least one blade extending along a longitudinal axis
wherein one or more temperature sensors are configured to operate one or more controllers when one or more threshold temperatures in the building interior is/are reached.

5. The heat exchanger of claim 6 wherein the shape and location of the bosses is selected to improve the distribution of a fluid flow through at least one of the heat exchange channels.

6. The heat exchanger of any one of claims 5-7 wherein a heat transfer layer is provided between the first and second heat exchange channels, and wherein the heat transfer layer is supported by one or more of the cylindrical or conical bosses.

7. The heat exchanger of any one of claims 5-8 wherein the body is constructed from a mouldable or 3D printable insulating material.

8. A fan/turbine of claim 2 or 6 comprising a rotor rotatable mounted within a housing, the rotor comprising an elongate central portion having a longitudinal axis, and at least one blade extending from the central portion, the or each blade having a first substantially helically shaped portion and a second substantially helically shaped portion, the second substantially helically shaped portion having an opposite chirality to the first substantially helically shaped portion.

9. The fan/turbine of claim 10 wherein a first opening is provided on a first side of the housing substantially axially aligned with an intersection of the first and second substantially shaped portions.

10. The fan/turbine of claim 10 wherein the first portion is substantially continuous with the second portion.

11. The fan/turbine of claim 11 or 12 wherein second and third openings are provided which are longitudinally offset from a centre of the first opening.

12. The fan/turbine of claim 10, 12 or 13 wherein the central portion cooperates with the internal surface configuration of the housing thereof and the outer portions have at least one further portion wherein a diameter of the blades decreases.

13. A fan/turbine comprising a rotor rotatable mounted in a housing, the rotor comprising an elongate central portion having a longitudinal axis, at least one pair of blades comprising a first blade and a second blade offset from the first blade, the first blade having a root which is substantially helically shaped to the longitudinal axis and a concave pressure face, the second blade having a having a root which is substantially helically shaped to the longitudinal axis and a substantially convex pressure face, a first opening provided in a first side of the housing and axially aligned with the first blade, and a second opening provided in a second side of the housing opposite the first side, the second opening axially aligned with the second blade.
